(19) United States
(12) Patent Application Publication
(10) Pub. No.: US 2023/0246901 A1
(43) Pub. Date: Aug. 3, 2023

(54) KEY PERFORMANCE INDICATOR MONITORING, PREDICTING AND ANOMALY DETECTION SYSTEM SYSTEM AND METHOD

(71) Applicant: Rakuten Mobile, Inc., Tokyo (JP)

(72) Inventors: Vishvesh TRIVEDI, Tokyo (JP); Anshul BHATT, Tokyo (JP); Akshaya KADIDAL, Karnataka (IN)

(21) Appl. No.: 17/589,684

(22) Filed: Jan. 31, 2022

(51) Int. Cl. H04L 41/0604; H04L 41/0893; H04L 41/22; H04L 41/0695; G06F 11/34

(52) U.S. Cl. CPC H04L 41/0604; H04L 41/0893; H04L 41/22; H04L 41/0695; G06F 11/3428

(57) ABSTRACT

A method includes causing an evaluation profile user interface to be output by a display. The evaluation profile user interface includes a key performance indicator (KPI) input field to receive a user input identifying one or more selected KPIs, one or more parameter input fields to receive one or more additional user inputs, and one or more evaluation input fields to receive one or more anomaly detection instructions based upon which the one or more selected KPIs are processed to determine an anomalous condition of the one or more selected KPIs. The user inputs and the anomaly detection instruction(s) are processed to generate a configured evaluation profile. At least one of received current performance data or historical performance data is processed based on the configured evaluation profile to determine that the received current performance data or the historical performance data indicates an active anomaly or a predicted anomaly.

### BACKGROUND

Network operators, network service providers and device manufacturers (e.g., wireless, cellular, etc.) are continually challenged to deliver value and convenience to consumers by, for example, providing compelling communication networks and network services that are dependable and capable of being flexibly constructed, scalable, diverse, and economically operated. To provide such communication networks and network services, network operators, network service providers and device manufacturers often track key performance indicators (KPIs) that are indicative of an operating state of a communication network and/or various network services and/or network devices.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a KPI monitoring, predicting and anomaly detection system, in accordance with one or more embodiments.

FIG. 2 is a diagram of a graphical user interface, in accordance with one or more embodiments.

FIG. 3 is a diagram of a graphical user interface, in accordance with one or more embodiments.

FIG. 4 is a diagram of a graphical user interface, in accordance with one or more embodiments.

FIG. 5 is a diagram of a graphical user interface, in accordance with one or more embodiments.

FIG. 6 is a diagram of a graphical user interface, in accordance with one or more embodiments.

FIG. 7 is a diagram of a graphical user interface, in accordance with one or more embodiments.

FIG. 8 is a diagram of a graphical user interface, in accordance with one or more embodiments

FIG. 9 is a diagram of a graphical user interface, in accordance with one or more embodiments.

FIG. 10A is a diagram of a graphical user interface, in accordance with one or more embodiments.

FIG. 10B is a diagram of a graphical user interface, in accordance with one or more embodiments.

FIG. 11 is a diagram of a graphical user interface, in accordance with one or more embodiments.

FIG. 12 is a diagram of a graphical user interface, in accordance with one or more embodiments.

FIG. 13 is a diagram of a graphical user interface, in accordance with one or more embodiments.

FIG. 14 is a diagram of a graphical user interface, in accordance with one or more embodiments.

FIG. 15 is a diagram of a graphical user interface, in accordance with one or more embodiments.

FIG. 16 is a diagram of a graphical user interface, in accordance with one or more embodiments.

FIG. 17 is a flowchart of a process for monitoring one or more KPIs, predicting one or more KPIs, detecting anomalies in or more KPIs and/or predicting anomalies in one or more KPIs, in accordance with one or more embodiments.

FIG. 18 is a functional block diagram of a computer or processor-based system upon which or by which an embodiment is implemented.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows may include embodiments in which the first and second features are formed or positioned in direct contact, and may also include embodiments in which additional features may be formed or positioned between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of an apparatus or object in use or operation in addition to the orientation depicted in the figures. The apparatus may be otherwise oriented (rotated 90 degrees or at other orientations) and the spatially relative descriptors used herein may likewise be interpreted accordingly.

Communication networks and network services are often provided by static or inflexible systems that are difficult to configure, scale, and deploy over various target areas. Dependable provision of communication networks and/or network services that are capable of being flexibly constructed, scalable and diverse is often reliant on the collection, analysis and reporting of information regarding multiple network functions, network services, network devices, etc. that affect the performance, accessibility, configuration, scale, and/or deployment of a communication network, various network functions, network services, and the like.

Network service providers often deploy network monitoring systems that track various key performance indicators (KPIs) of an aspect of a network for determining how well that aspect and/or the network is performing. KPIs are often KPI values and/or trends that are compared to certain thresholds to indicate the relative performance of a communication network, network service, network device, etc. The KPI values are often based on monitoring data or historical performance data, referred to herein as KPI data.

Sometimes, when a KPI value for a certain network function, network service or feature is below a preset threshold, the KPI value may imply that the network is operating normally, whereas when the KPI value is above or equal to the preset threshold, the KPI value implies that the network is operating below expectation, which in turn may indicate that some unexpected event (e.g., a hardware failure, capacity overload, a cyberattack, etc.) has occurred. Accordingly, a series of actions can be carried out by the network monitoring system such as alerting the network operator, shifting a network function from a problematic server to a healthy server, temporarily shutting down the network, or some other suitable action. Of course, depending on the network configuration, a condition in which the KPI value is higher than or equal to a threshold can also indicate that the network is operating normally, while a condition in which the KPI value is below the threshold indicates that the network is operating below expectation. Several other types of threshold configurations are possible as the threshold configurations may vary depending on the needs of a specific user or specific network operator, depending on individual preference, type of KPI being monitored, type of KPI created by a user for monitoring, type of KPI data that is processed for monitoring a KPI, and the like.

Network operators often coordinate and deploy communication networks that include network services (e.g., hardware, software, etc.) that are provided by one or more network service providers. Each network service provider often uses a corresponding monitoring system to monitor performance of the network service(s) provided by that network service provider to gather various KPI data usable for determining KPI values indicative of the state of the communication network. The network service providers send the KPI data to the network operator for monitoring the status of the communication network in consideration of the KPI data associated with the network service(s) provided by each network service provider. For example, the network operator uses the KPI data supplied from the network service providers to evaluate the quality of services provided by each of the network service providers.

By monitoring the KPIs of a communication network, an anomaly in the operating state of the network can be detected and appropriate action can be carried out. Accordingly, anomaly detection and prediction of the KPIs in a communication network are important aspects of network monitoring. Monitoring KPIs to detect anomalies in a communication network can produce information such as historical KPI values and/or historical KPI data that shows the trends in the occurrence of anomalies in the KPIs which can be indicative of anomalies in various aspects of the communication network corresponding to said KPIs. Predicted KPI data that is based on historical KPI values and/or historical KPI data can be used for forecasting or predicting an anomaly in the KPIs based on one or more predicted KPI values. Monitoring KPIs and/or predicting KPIs can be useful for assisting a network operator with scheduling maintenance, network improvement, and for implementing preventive actions to avoid an interruption of expected performance of the communication network.

Network operators consistently check KPIs to, for example, ensure validity and stability of the communication network. Then, based on a determination that an anomaly occurs in one or more KPIs, take an appropriate action such as making a change in network service providers or network devices that are used to provide one or more network services that are malfunctioning to one or more alternative network service providers and/or one or more alternative network devices to ensure the communication network is operating and available for consumers. Similarly, predicting anomalies in the KPIs is useful for pre-empting a potential issue in the operation of the communication network.

Communication networks often involve network services across multiple domains (such as radio area network (RAN), base station subsystem (BSS), platform, core network, etc.), various technologies (such as 3G, 4G, LTE, 5G, etc.), multiple locations, various software interfaces, multiple devices, etc. that are proprietary and/or optimized by a specific network service provider(s).

As the communication network evolves and improves, a single communication network may involve an ever-changing quantity of network service providers for providing network services and/or that are associated with providing network services associated with various aspects of the communication network (e.g., domains, technologies, locations of services, etc.) and, as a result, the state of the communication network may vary dynamically with the addition and/or subtraction of network service providers, a change in one or more network services, etc. Accordingly, monitoring the operating state of the communication network based on KPI data provided by multiple network service providers becomes more challenging. For example, a single user may be in charge of monitoring multiple KPIs at the same time to determine if an anomaly in one or more KPIs occurs. Such a user may, for example, monitor KPIs of a similar aspect of the communication network for different location, KPIs of different aspects of the communication network for one location, KPIs of different network service providers (e.g., vendors) for similar or different aspects of network, or a combination thereof.

Further, the user may want to detect and/or predict anomalies for one KPI differently for different locations (e.g., detect and/or predict anomalies of the KPI more frequently in busy cities but less frequently in less busy cities, etc.) and/or according to a specific aspect of the communication network (e.g., detect and/or predict anomalies on network traffic during a specific event and/or time period such as a single-occurrence sporting event, a series of sporting events, multiple series of sporting events, etc.).

Furthermore, multiple users may be involved in monitoring anomalies in KPIs of the communication network. Some of the users may be required to monitor anomalies in a same KPI, but each user may want to detect and/or predict anomalies in the same KPI in individually different manners, because what is considered to be “normal” to one user may be different for another user and, similarly, what is considered to be “abnormal” to one user may be different for another user.

As the status of the communication network varies dynamically, an anomaly that is being detected and/or predicted may be accurate for a specific time period, but can be inaccurate for another time period. Users are thus often always monitoring KPIs to determine the status of the communication network and frequently configure/reconfigure monitoring systems to detect and/or predict anomalies in the KPIs in an attempt to reduce the rate of false alarming regarding issues in the operating state of the communication network. Doing so, however, is unduly burdensome to the users of the monitoring system, particularly when a user would like to monitor multiple KPIs at the same time.

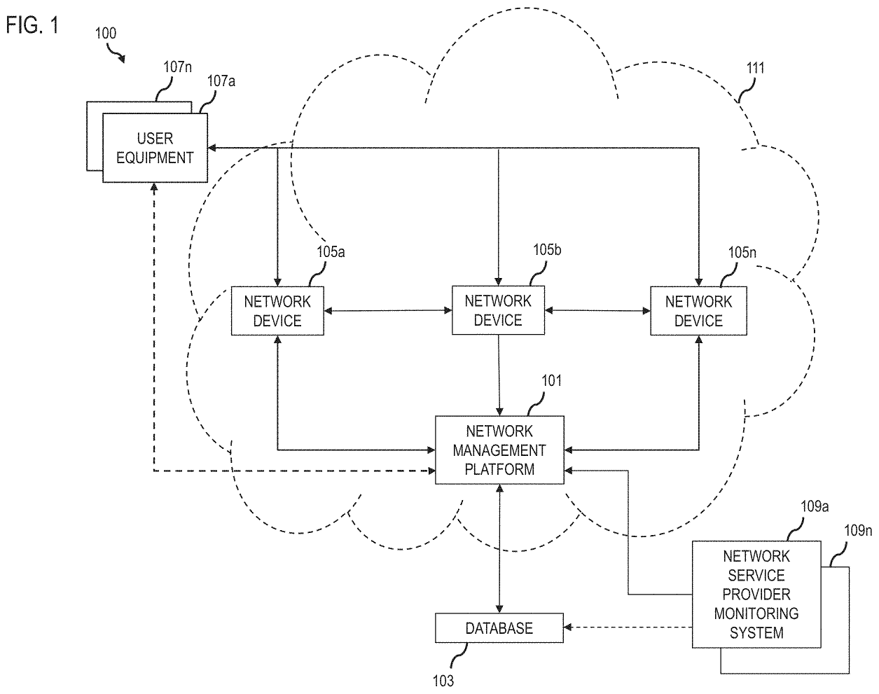

FIG. 1 is a diagram of a KPI monitoring, predicting and anomaly detection system 100, in accordance with one or more embodiments.

System 100 makes it possible to gather KPI data regarding and/or from multiple network service providers, multiple domains, multiple technologies, multiple locations, or a combination thereof. Further, the system 100 makes it possible for a user in charge of monitoring one or more KPIs to select one or more KPIs from multiple network service providers (e.g., vendors), multiple domains, multiple technologies, multiple locations, etc., and then configure an evaluation profile to detect and/or predict anomalies in the selected KPIs in the user's desired manner.

In some embodiments, the system 100 is configured to enable a user to customize the detection and/or prediction of anomalies of one or more KPIs at one time. In some embodiments, the system 100 is configured to enable multiple users to customize the detection and/or prediction of anomalies of one or more KPIs at one time. In some embodiments, the system 100 is configured to facilitate the simultaneous detection, prediction, and presentation of multiple KPIs and associated anomalies in a single display (e.g., one graphical user interface display, in one dashboard, etc.). In some embodiments, the system 100 is configured to facilitate continuous detection and/or prediction of anomalies in one or more target KPIs in a user's desired manner.

System 100 comprises a network management platform 101, a database 103, one or more network devices 105a-105n (collectively referred to as network devices 105), and one or more user equipment (UE) 107a-107n (collectively referred to as UE 107). The network management platform 101, the database 103, the one or more network devices 105, and/or the one or more user equipment (UE) 107 are communicatively coupled by way of a communication network 111. In some embodiments, the communication network 111 is orchestrated by the network management platform 101 which combines a plurality of network services provided a network service provider via the network devices 105. In some embodiments, the network management platform 101 is a network orchestrator that implements the communication network 111. In some embodiments, the network management platform 101 is a portion of a network orchestrator that implements the communication network 111.

The network service providers associated with the network services provided have corresponding network service provider monitoring systems 109a-109n (collectively referred to as network service provider monitoring system 109). The network service provider monitoring systems 109 collect KPI data associated with the network services provided to communication network 111 and send that KPI data to the network management platform 101 to facilitate monitoring of the state of the communication network 111. In some embodiments, the network management platform 101 stores the KPI data in the database 103. In some embodiments, one or more of the network service monitoring systems 109 are communicatively coupled to the database 103 and the KPI data is sent by the network service provider monitoring systems 109 to the database 103 without the network management platform 101 intervening.

Network management platform 101 is configured to generate one or more evaluation profiles based on a plurality of parameters input by a user to facilitate illustrating and evaluating KPI values, trends in the KPI values, anomalies in the KPI values, and/or predicting anomalies in the KPI values based on the KPI data received from the network service provider monitoring systems 109 and/or retrieved from the database 103.

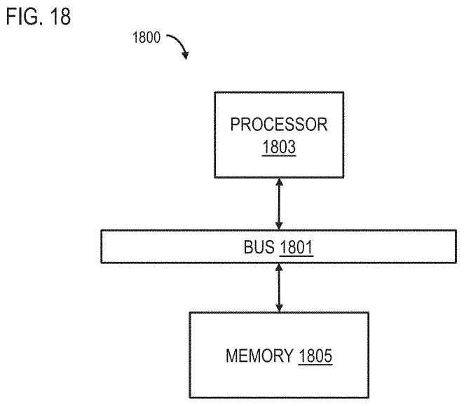

In some embodiments, network management platform 101 comprises a set of computer readable instructions that, when executed by a processor such as a processor 1803 (FIG. 18), causes network management platform 101 to perform the processes discussed in accordance with one or more embodiments. In some embodiments, network management platform 101 is remote from the network devices 105. In some embodiments, network management platform 101 is a part of one or more of the network devices 105. In some embodiments, one or more processes the network management platform 101 is configured to perform is divided among one or more of the network devices 105 and/or a processor remote from the network devices 105. In some embodiments, the network management platform 101 is at least partially implemented by a UE 107.

In some embodiments, database 103 is a centralized network repository having searchable information stored therein that includes KPI data provided by network service provider monitoring system 109, historical KPI data, rules defining various KPIs, network functions capable of being implemented in the network involving one or more of network usage, timing, connected devices, location, network resource consumption, cost data, example network KPIs, KPI monitoring profiles corresponding to one or more users, KPI evaluation profiles corresponding to one or more users, other suitable elements or information, or a combination thereof. In some embodiments, database 103 is a memory such as a memory 1805 (FIG. 18) capable of being queried or caused to store data in accordance with one or more embodiments. In some embodiments, the network management platform 101 and the database 103 together form a network orchestrator that implements the communication network 111.

In some embodiments, network management platform 101 generates a graphical user interface that is output to a display by way of a UE 107 or a terminal associated with network management platform 101 for a user (e.g., a network operator, a network administrator, and any personnel which would like to or is responsible to monitor the state of the communication network 111), so as to allow the user to input or select parameters for configuring an evaluation profile (e.g., for monitoring anomalies in the one or more KPIs indicative of an abnormality in an expected operating state of the communication network 111). Network management platform 101 generates the evaluation profile(s) specified by the user based on parameters input or selected by the user, and causes the generated profile(s) to be stored in database 103. In some embodiments, the user interface is accessible via a web browser such as by way of a website or a web browser plug-in, is accessible via an application pre-installed in the UE 107, or is accessible via some other suitable means. In some embodiments, network management platform 101 causes the generated illustration and/or evaluation profiles to be stored in a server, in a memory of a UE 107, or some other suitable location.

In some embodiments, the user interface output by UE 107 enables a user to select one or more target KPIs and to configure how detection and prediction of anomalies of the target KPI(s) should be performed. The user interface output by UE 107 is configured to enable a user to input details of one or more desired KPIs to select which KPI data should be involved. For example, the user interface output by UE 107 is configured to receive one or more user inputs identifying title/name of KPI(s), from which domain(s), which network service provider(s), which technology(ies), which location(s), a desired time interval (e.g., starting time and ending time, a specific time duration), and/or other suitable parameters.

In some embodiments, the user-selected configuration is stored as an evaluation profile, and the network management platform 101 continuously evaluates the KPI(s) included in the evaluation profile in real-time, and performs an action (e.g., sending alert to the network operator/network service provider, scheduling maintenance, etc.) based on the evaluation.

In some embodiments, the network management platform 101 is configured to evaluate the KPI(s) included in the evaluation profile on demand.

In some embodiments, the network management platform 101 is configured to evaluate the KPI(s) included in the evaluation profile according to a predefined schedule defined in the evaluation profile. In some embodiments, the predefined schedule includes defined moments within a selected time interval. In some embodiments, the predefined schedule is based on a series of times in perpetuity from a start time included in the evaluation profile. In some embodiments, the network management platform 101 is configured to evaluate KPI(s) based on some other suitable timing, schedule or time interval having a start time and an end time, schedule or time interval having a start time and an unbounded end time, continuously or on demand.

In some embodiments, the user interface also makes it possible for a user to configure how the selected KPI(s) included in the evaluation profile should be presented, to save the user-selected configuration, and to output a graphical representation (e.g., list, graph, chart, etc.) showing detailed information regarding current performance data and/or historical performance data of the KPI(s) in the evaluation profile, in real-time or on demand.

In some embodiments, the network management platform 101 and database 103 are configured to be a centralized KPI monitoring and evaluation system that is apart from, or included as component of a network orchestrator that implements the communication network 111, which is capable of continuously monitoring any KPI data provided by any of a plurality of network service providers involved in the communication network 111, evaluating the KPI data to determine and/or predict anomalies in the KPI data, and performing an action based on the evaluation. In some embodiments, the network management platform 101 is configured to generate a graphical representation (e.g., a list) that comprises multiple instances of received KPI data in real-time, and cause the graphical representation to be output by way of user interface showing detailed information of each of the target KPIs in real-time.

The network service provider monitoring system(s) 109 of each of the plurality of network service providers continuously monitor their own corresponding network services and periodically send at predetermined times (e.g., every 5 minutes, every 15 minutes, every 30 minutes, etc.) the monitored KPI data to the network management platform 101. The network management platform 101 causes the monitored KPI data to be stored in database 103. In some embodiments, as discussed above, the monitored KPI data is sent directly to the database 103. In some embodiments, the database 103 is a centralized data storage which is controlled by the network operator. In some embodiments, the network management platform 101 checks the database 103 for newly received KPI data and/or retrieves KPI data stored in the database for illustration and/or evaluation as-needed for continuous, periodic, or on-demand monitoring.

The KPI data is communicated from the network service provider monitoring systems 109 to the network management platform 101 and/or the database 103 via one or more of a wireless communication channel, a wired communication channel, enhanced messaging service (EMS), email messaging, data packet transmission, or some other suitable type of data transmission, which is optionally the same or different among the plurality of network service providers.

In some embodiments, the network management platform 101 continuously monitors the KPI data by processing received KPI data that is stored in the database 103. In some embodiments, the network management platform 101 evaluates the received KPI data by searching and extracting an evaluation profile that is stored in a memory having connectivity to the network management platform 101, the database 103, or some other suitable memory after being configured by a user for monitoring and evaluating the received KPI data.

The network management platform 101 compares the recorded information associated with the received KPI data with the information included in the evaluation profile and generates an output of the evaluation results. In some embodiments, the output of results comprises a list containing the recorded information, a graph containing details illustrating the recorded information regarding the received KPI data associated with a particular network service, for example, or some other suitable output usable for demonstrating actual or predicted anomalies in target KPI(s) and/or causing an action to occur (e.g., an action that changes an operating state of the communication network 111, changes network services, changes network devices, changes network service providers, or some other suitable action).

In some embodiments, network management platform 101 is configured to retrieve historical KPI data of the user's desired KPI(s) based on the evaluation profile and continuously monitor the historical KPI data. Upon receiving a first user input, the network management platform 101 is configured to cause the historical KPI data of the user's desired KPI(s) to be output to a user interface based on the evaluation profile in a list and/or graphical format for viewing by a user. Upon receiving a second user input, the network management platform 101 is configured to detect an anomaly in the historical KPI data and present the anomaly to the user via the user interface based on the evaluation profile. In some embodiments, the detected anomaly is highlighted in the user interface to facilitate easy recognition of the anomaly by the user viewing the graphical user interface.

In some embodiments, the network management platform 101 is configured to generate a prediction of future KPI data for the user's desired KPI(s) and present the predicted KPI data by way of the user interface based on the evaluation profile. In some embodiments, the prediction includes a prediction of an anomaly in the KPI data at a later time. In some embodiments, the predicted KPI data and the historical KPI data are presented on the same user interface.

In some embodiments, the network management platform 101 is configured to automatically retrieve the latest KPI data based on the evaluation profile, automatically update the historical KPI data of the user's desired KPI(s) based on the latest KPI data, and update the presentation of the historical KPI data of the user's desired KPI(s). The network management platform 101 then, based on the evaluation profile and the updated historical KPI data, is configured to automatically detect an anomaly based on the updated presentation of the historical KPI data and present the updated anomaly to the user via the user interface. In some embodiments, the network management platform 101 is configured to automatically generate an updated prediction of future KPI data of the user's desired KPIs and update the presentation of the prediction of the future KPI data based on the evaluation profile. Then, based on the results of the prediction of the anomaly in the future KPI data, cause an action to be performed such as sending an alarm to a user, shifting the load of a network, activating a system cooling system, perform virus scanning, or some other suitable action.

In some embodiments, when a user (e.g., a network operator, a network service provider, and/or any personnel that would like to or is responsible to monitor the system) wants to monitor one or more KPIs, the network management platform 101 makes it possible for a user to access to the centralized platform via a UE 107. The network management platform 101 determines the identity of the user based on user credentials, access device, or some other suitable manner, and provides a user interface to the user. In some embodiments, the network management platform 101 limits functions available to the user by way of the user interface depending on the type of user (e.g., a regular user may have access to fewer functions than a VIP user which provides essential/important services, a network administrator that may have access to all functions, etc.).

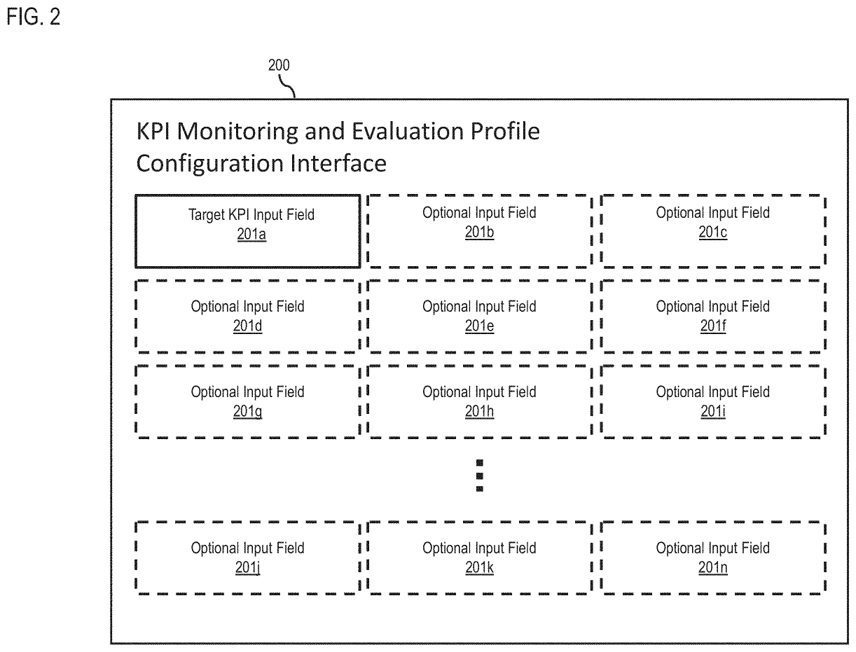

FIG. 2 is a diagram of a graphical user interface 200, in accordance with one or more embodiments. Network management platform 101 is configured to cause graphical user interface 200 to be output to a display. Graphical user interface 200 is a KPI monitoring and evaluation profile configuration interface. Graphical user interface 200 comprises a target KPI input field 201a configured to receive a first user input identifying one or more KPIs of a plurality of available KPIs. Each KPI of the plurality of available KPIs is indicative of a corresponding operating state or a performance of a communication network. In some embodiments, the network management platform 101 is configured to limit a quantity of target KPIs selected, input, or included in an evaluation profile to be a preset quantity that is less than the total quantity of available KPIs based on a user credential associated with a user to which a configured evaluation profile is to be assigned and/or based on a user credential associated with a user that is creating the evaluation profile.

In some embodiments, graphical user interface 200 further comprises one or more optional user input fields 201b-201n configured to receive one or more additional user inputs for designating one or more additional parameters associated with determining an anomalous condition in one or more KPIs.

For example, in some embodiments, the one or more optional user input fields 201b-201n optionally include one or more parameter input fields configured to receive one or more additional user inputs identifying at least one of a selected wireless domain (e.g., RAN, Core network, etc.) of a plurality of wireless domains, a selected service provider of a plurality of service providers associated with providing a network service to the communication network or a selected vendor for providing a service associated with the selected wireless domain, a selected wireless technology (e.g., 3G, 4G, LTE, 5G, etc.) of a plurality of wireless technologies associated with the network service, a selected time interval for monitoring the one or more selected KPIs, a geographical location within which the network service is provided, at least one network device by which the network service is provided, or some other suitable parameter.

In some embodiments, a network service provider name input field is configured to receive a user input identifying a network service provider name identifying a selected network service provider of a plurality of network service providers associated with providing a network service to a communication network (e.g., communication network 111), a wireless domain input field is configured to receive a user input identifying a selected wireless domain of a plurality of wireless domains, and a wireless technology input field is configured to receive a user input identifying a selected wireless technology of a plurality of wireless technologies. In some embodiments, one or more of user input fields 201b-201n is excluded from the graphical user interface 200.

In some embodiments, one or more of the optional user input fields 201b-201n is an evaluation input field. For example, in some embodiments, user interface 200 includes one or more evaluation input fields configured to receive one or more anomaly detection instructions based upon which the one or more selected KPIs are processed to determine an anomalous condition of the one or more selected KPIs. The one or more evaluation input fields comprise, for example, an option to select at least one of an active anomaly for detecting an instance of the one or more selected KPIs being outside of an expected range based on current performance data received from at least one selected service provider or the at least one network device as the current performance data is received, or a predicted anomaly for detecting a forecast deviation of the operating state from the expected range based on a projected KPI value for at least one of the one or more selected KPIs determined based on historical performance data and a future time period indicated by way of one or more of the anomaly detection instructions. In some embodiments, the one or more evaluation input fields is configured to receive a user input indicating that the selected time interval for monitoring the one or more selected KPIs extends from a start time to an end time. In some embodiments, the one or more evaluation input fields is configured to receive a user input indicating that the selected time interval for monitoring the one or more selected KPIs extends from a start time (e.g., a time before the configured evaluation profile is generated, a time after the configured evaluation profile, etc.) to an end time after the start time. In some embodiments, the one or more evaluation input fields is configured to receive a user input indicating that the selected time interval for monitoring the one or more selected KPIs extends from a start time that is one of a moment that the evaluation profile is created, a moment before the evaluation profile is created, or a moment after a time the evaluation profile is created, according to a user input, continuously and in perpetuity.

In some embodiments, the one or more optional user input field 201b-201n comprises a user input field configured to receive a user input identifying a quantity of values of the KPI data to be included in a graphical view. In some embodiments, the one or more optional user input fields 201b-201n optionally include a user input field configured to receive a user input identifying a period of time for illustrating the KPI data. In some embodiments, the one or more optional user input fields 201b-201n optionally include a user input field configured to receive a user input identifying one or more types of graphs of the values of the KPI data over the period of time. In some embodiments, the different types of graphs include at least one of a pie graph, a bar graph, a histogram, a line plot, a frequency table, or some other suitable graphical or tabular presentation. In some embodiments, the one or more optional user input fields 201b-201n optionally include user input fields for receiving a user input that identifies two or more of the types of graphs to cause the two or more types of graphs to be concurrently displayed based on an instruction to view KPI data associated with the one or more network services provided to the communication network. In some embodiments, the one or more optional user input fields 201b-201n optionally include a user input field configured to receive a user input identifying an expected value or range of values of KPI data corresponding to the one or more selected KPIs.

In some embodiments, the one or more optional user input fields 201b-201n include a user input field configured to receive a user input identifying that two or more graphical displays of two or more selected KPIs are to be concurrently displayed. In some embodiments, the one or more optional user input fields 201b-201n include a user input field configured to receive a user input identifying that two or more graphical displays of two or more selected KPIs are to be concurrently displayed in a same graphical representation (e.g., a graph, a chart, etc.). In some embodiments, the one or more optional user input fields 201b-201n include a user input field configured to receive a user input identifying that two or more graphical displays of two or more selected KPIs are to be concurrently displayed in an individual graphical representation in a same display.

In some embodiments, the one or more optional user input fields 201b-201n include a user input field configured to receive a user input identifying one or more threshold comparison parameters indicating a basis upon which an active anomaly or the predicted anomaly is determined. In some embodiments, the threshold comparison parameter is one of greater than, equal to, or less than a baseline threshold value, and the active anomaly or the predicted anomaly is determined based on an actual breach or a predicted breach of the baseline threshold value in accordance with the threshold comparison parameter. In some embodiments, the threshold comparison parameter is a confidence band defining a range of a maximum threshold value and a minimum threshold value, and the active anomaly or the predicted anomaly is determined based on an actual breach or a predicted breach of the maximum threshold value or the minimum threshold value. In some embodiments, the threshold comparison parameter defines a tolerance range of change over time for the selected one or more KPIs, and the active anomaly or the predicted anomaly is determined based on an actual breach or a predicted breach of the tolerance range of change over time, indicating a trend of reduced quality of the network service, in accordance with the threshold comparison parameter.

In some embodiments, the one or more optional user input fields 201b-201n include a user input field configured to receive a user input identifying a direction of deviation from the expected KPI values and the actual KPI values received by the network management platform 101. For example, such a direction of deviation may include greater than, less than, equal to, or a combination thereof.

In some embodiments, the one or more optional user input fields 201b-201n optionally include a user input field configured to receive a user input identifying a geographical region within which the one or more network services are provided to the communication network to present illustration and/or evaluation of the KPI data corresponding to the selected geographical region. In some embodiments, the one or more optional user input fields 201b-201n include a user input field configured to receive a user input identifying one or more alert types caused to be output based on a determination that received current performance data or the historical performance data indicates an active anomaly or a predicted anomaly. In some embodiments, the one or more alert types comprise at least one of a text message, an email, a graphical image output to the display, a voice call, a pager message, or some other manner by which an alarm is capable of being communicated to a recipient. In some embodiments, the one or more optional user input fields 201b-201n optionally include a user input field configured to receive a user input identifying one or more recipients of the alert. In some embodiments, the one or more optional user input fields 201b-201n optionally include a user input field configured to receive a user input identifying a time range for outputting the alert. In some embodiments, the time range for outputting the alert is different from the period of time to monitor the KPI data received or predicted. In some embodiments, the one or more optional user input fields 201b-201n include a user input field configured to receive a user input identifying user credentials for creating and/or accessing an illustration and/or evaluation profile. In some embodiments, the user credential indicates the user to which the configured evaluation profile is assigned is a first user having a first access-level type or a second user having a second access-level type corresponding to a higher level of admin rights than the first access-level type within the system for monitoring the one or more selected KPIs, and/or the preset number of KPIs that are allowed by network management platform 101 to be selected based on the user credential is greater for the second user than the first user.

In some embodiments, one or more of the user input fields 201a-201n is configured to receive parameters manually inputted into the user input fields (e.g., via keyboard, voice control, and the like). Alternatively, the network management platform 101 causes one or more of the user input fields 201a-201n to provide (e.g., in the form of a drop-down list, pop-out window, auto-complete text, autocorrect text, radio buttons, or some other suitable options) available parameter options or parameters suggested by the network management platform 101 based on input or other inputted/selected parameters, and the user can simply select the available parameter options from the drop-down list, pop-out window, radio buttons, or other suitable options, or accept the auto-complete text or autocorrect text to fill the user input field 201a-201n. In some embodiments, the user can simply input a keyword(s) into one or more of the user input fields 201a-201n, and the network management platform 101 will then provide a drop-down list, pop-out window, radio buttons, etc. that comprise available and/or suggested parameters associated with the input keyword(s).

In some embodiments, the graphical user interface 200 is both an illustration profile configuration interface and an evaluation profile configuration interface. In some embodiments, the graphical user interface 200 is split into multiple displays, wherein one display is an illustration profile creation interface including at least one or more of user input fields 201a-201n associated with generating and illustrating the graphical and/or tabular outputs of the received KPI data according to the parameters that are input, and another display that is an evaluation profile creation interface separately displayed from the illustration profile creation interface which includes one or more of user input fields 201a-201n associated with generating the evaluation profile and causing alerts for detected anomalous conditions of the one or more selected KPIs.

In some embodiments, one or more of the user input fields 201a-201n included in the illustration profile creation interface and one or more of the user input fields 201a-201n included in the evaluation profile configuration interface are identical, appearing in separate graphical user interface displays for both the illustration profile creation interface and the evaluation profile creation interface.

In some embodiments, the network management platform 101 is configured to appropriately process information input into the various user input fields 201a-201n for purposes of generating the illustration profile and/or the evaluation profile in accordance with corresponding instructions directing the network management platform 101 to use which user input from which user input field 201a-201n for which purpose, and causes the illustration profile and the evaluation profile to be stored in the database 103.

The graphical user interface 200 enables a user to select and configure how the network management platform 101 should illustrate current and/or historical KPI data. The user inputted configuration will be saved in the illustration profile. Subsequently, the selected data will be presented to the user in the form of a graphical representation based on the illustration profile. In some embodiments, when new KPI data is received for a selected network service by the network management platform 101 and/or determined by the network management platform 101 to be stored in database 103, the network management platform 101 automatically retrieves the updated KPI data (including the new KPI data) from the database 103 based on the illustration profile, and then updates the graphical representation based on the updated KPI data and the illustration profile. Accordingly, the network management platform 101, in some embodiments, is configured to provide a graphical representation which continuously monitors and illustrates the received KPI data in real-time. In some embodiments, if the graphical output comprises a tabular form or list, information in the table or list will also update periodically based on the illustration profile created by the user.

Similar to creating an illustration profile, the user can configure the way the network management platform 101 evaluates the current and/or historical KPI data provided by inputting the desired configuration via the user interface 200, or another user interface similar to user interface 200 but comprising user input fields for inputting and/or selecting optional parameters provided by the network management platform 101 that are associated with evaluating the KPI data for anomalous conditions.

In some embodiments, the user interface for creating and configuring the evaluation profile is only made available to an authorized user. In some embodiments, when triggering the user interface for creating and configuring the evaluation profile, the network management platform 101 causes a user credential input window or user input field to be presented to request the user to input, for example, a password, a user ID, and/or some other suitable information to verify the identity of the user.

In some embodiments, only some authorized users have rights to update and/or configure evaluation profiles. For example, if users having access to the network management platform 101 have varying levels of authority, the network management platform 101 is optionally configured to prevent users that have a level of authority below a preset level of authority from creating an evaluation profile and/or prevent users that have a level of authority below a preset level of authority from modifying or updating a pre-existing evaluation profile. In some embodiments, users having authority to access the network management platform 101 are able to create evaluation profiles that are determined to be original and non-duplicative with pre-existing evaluation profiles. In some embodiments, if a user has a level of authority greater than or equal to a preset level of authority, such a user is allowed by the network management platform 101 to modify or update a pre-existing evaluation profile and/or create a duplicative or overlapping evaluation profile. In some embodiments, the network management platform 101 is configured to allow any user having access to the network management platform to create on-demand or autonomous illustration profiles, but restricts the rights to create evaluation profiles to those having a level of authority greater than or equal to a preset level of authority. Even still, in some embodiments, the network management platform 101 is configured to allow users having access to the network management platform 101 to create on-demand or autonomous illustration profiles, allow only users having a level of authority greater than or equal to a first preset level of authority to create evaluation profiles, and allow only users having a level of authority greater than or equal to a second preset level of authority greater than the first preset level of authority to update or modify a pre-existing evaluation profile. In some embodiments, network management platform 101 is configured to allow only users having a level of authority greater than the level of authority of the user that created the evaluation profile to update and/or modify a pre-existing evaluation profile created by another user. In some embodiments, network management platform 101 is configured to allow only users having a level of authority greater than or equal to the level of authority of the user that created the evaluation profile to update and/or modify a pre-existing evaluation profile created by another user. Rules that limit the authority to create and/or modify evaluation profiles helps to reduce the possibility of creating duplicative evaluation profiles that could lead to extraneous alerts being sent to a same recipient and/or helps to reduce consumption of system resources that could slow the response time and reduce the overall capabilities of the system 100.

In some embodiments, once an evaluation profile is updated, the network management platform 101 records the time of update and/or the changes log, which can then be presented to a user viewing the evaluation profile such that when another user wants to configure the same evaluation profile, the user will be able to understand that such an evaluation profile has been previously updated and may not require to be updated again, or the user will be informed that another user has updated or modify the user's own pre-existing evaluation profile.

In some embodiments, if the network management platform 101 determines that an evaluation profile with the same configuration has already been created, the network management platform 101 causes an alert (e.g., a pop-up window or on-screen message) to be presented to the user and the network management platform 101 will not create the evaluation profile in order to avoid duplicative evaluation profile and the wastage of system resources. In some embodiments, network management platform 101 is configured to cause a submit button in the graphical user interface (e.g., a submit icon, a save icon, a create icon, or other suitable user interface selectable icon) to be inoperable (e.g., grayed-out or some other indication of inoperability), notifying a user that a pre-existing duplicative evaluation profile exists, and the network management platform 101 will not create the evaluation profile in order to avoid duplicative evaluation profile and the wastage of system resources.

In some embodiments, the network management platform 101 will determine the type of the user (e.g., a VIP user, a user which is in-charge of monitoring critical services, a super admin, etc. based on the inputted user credentials) and provide an option to allow the user to create the same configuration profile after confirming that the same configuration profile should be created.

In some embodiments, before creating an evaluation profile, the network management platform 101 is configured to cause an alert to be present to the user based on a determination that a pre-existing evaluation profile, which is determined by the network management platform 101 to be similar, based on a comparison between the user's configuration input into the evaluation profile creation interface and any pre-existing evaluation profiles in accordance with at least one rule defining an allowable degree of similarity for generating a new evaluation profile. For example, when the network management platform 101 determines that the user's configuration input into the evaluation profile interface only differs from a pre-existing profile in terms of the start time and end time for monitoring a KPI “A”, the network management platform 101 causes a message to be presented to the user informing the same, and ask whether or not the user wants to configure and/or update the pre-existing evaluation profile instead of creating a new evaluation profile.

In some embodiments, similar to the illustration of data, once an evaluation profile has been created, the network management platform will continuously monitor and evaluate the KPI data received by the network management platform 101 and/or database 103 based on the evaluation profile. In some embodiments, when new KPI data has been received, the network management platform 101 will automatically retrieve the updated KPI data from the database 103 based on the evaluation profile and update the graphical representation (e.g., the graphical display and/or list of information) based on the updated KPI data. Accordingly, in some embodiments, the network management platform 101 provides a graphical representation which continuously monitors and evaluates the received KPI data in real-time. In some embodiments, the network management platform 101 provides a graphical representation which monitors and evaluates the received KPI data on-demand.

In some embodiments, whether autonomous or on-demand, if the network management platform 101 determines an active or predicted anomaly of the selected one or more KPIs based on current and/or historical KPI data received by the network management platform 101, the network management platform 101 causes an action to be performed such as sending an alert to the user that created the evaluation profile, a network administrator other than the user that created the evaluation profile, a designated recipient of the alert according to the evaluation profile, and/or the network service provider, and/or shifting a network service associated with the problematic network service provider to a network service provided by another network service provider, shifting the one or more network services to another network device, or some other suitable action to maintain or improve an operating state of the communication network 111 that may be affected by, indicated as being affected by, or assumed to be affected by the unexpected deviation in the KPI data that is received from that which is expected.

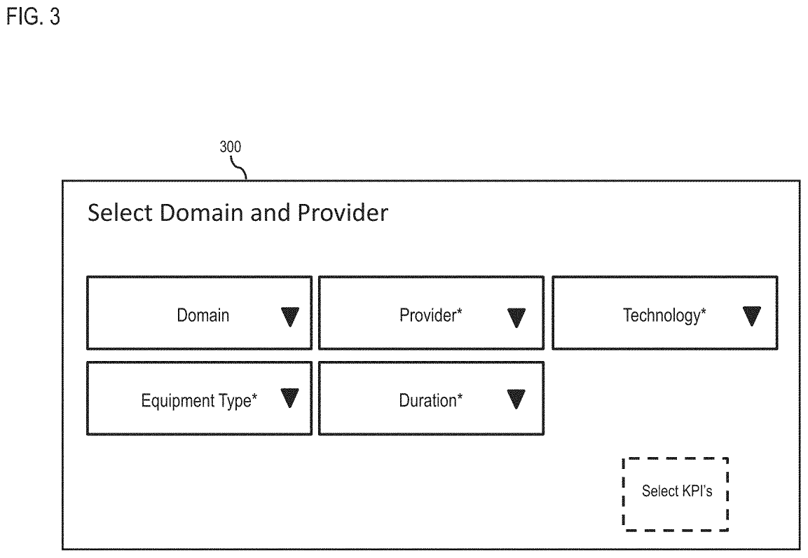

FIG. 3 is a diagram of a graphical user interface 300, in accordance with one or more embodiments. In some embodiments, graphical user interface 300 is an example of a portion of user interface 200 (FIG. 2) and/or one of two or more screens of user interface 200.

Graphical user interface 300 includes input fields that are configured to received user inputs indicative of a target domain, a selected network service provider, a selected technology, a selected equipment type, and a duration for monitoring the one or more selected KPIs.

In this example, a user can select the parameters associated with the KPIs (e.g., the target domain and network service provider) before selecting any target KPIs.

In some embodiments, domain input field facilitates the selection of one or more domain types such as Radio Access Network (RAN), Core Network, Network Transport, base station subsystem (BSS), Network Infrastructure, or some other suitable domain type.

In some embodiments, network service provider (e.g., Provider) input field facilitates the selection of one or more network service provider names (e.g., Provider A, Provider B, etc.)

In some embodiments, technology input field facilitates the selection of one or more technologies available for the selected domain and/or network service provider such as 3G, 4G, LTE, 5G, or some other suitable or available technology.

In some embodiments, equipment type input field facilitates the selection of one or more equipment types available for the selected domain, network service provider, and/or technology, such as Radio Interface Unit (RIU) of Distribute Antenna System (DAS), Remote Radio Head (RRH) of DAS, MACRO (eNodeB-based KPI), MACRO_CELL (Cell-based KPI; one eNodeB has multiple cellss), eNodeB, Virtualized Deployment Unit (VDU), Radio Interface Unit (RIUD), or some other suitable equipment type.

In some embodiments, duration input field facilitates the selection or input of any available duration, such as 5 minutes, 1 hour, 2 days, 1 week, 1 month, or some other suitable amount of time.

In some embodiments, user interface 300 includes an option to continue, confirm, go to next, proceed to select KPIs, hit enter, hit space, or some other suitable option to trigger a next portion of user interface 200, for example, for selecting one or more target KPIs.

In some embodiments, the next portion of user interface 200 is presented in the same dashboard/window with a previous portion of user interface 200, such as by displaying additional input fields to facilitate entry of various selected KPIs or other parameters that are viewable in the same screen or to enable the user to scroll down to access the next portion of user interface 200 after selecting the parameters in a previous portion of user interface 200. In some embodiments, a next portion of user interface 200 is provided in a subsequent view. If in a subsequent view, some embodiments enable a user to navigate back to a previous page or navigate forward to a next page.

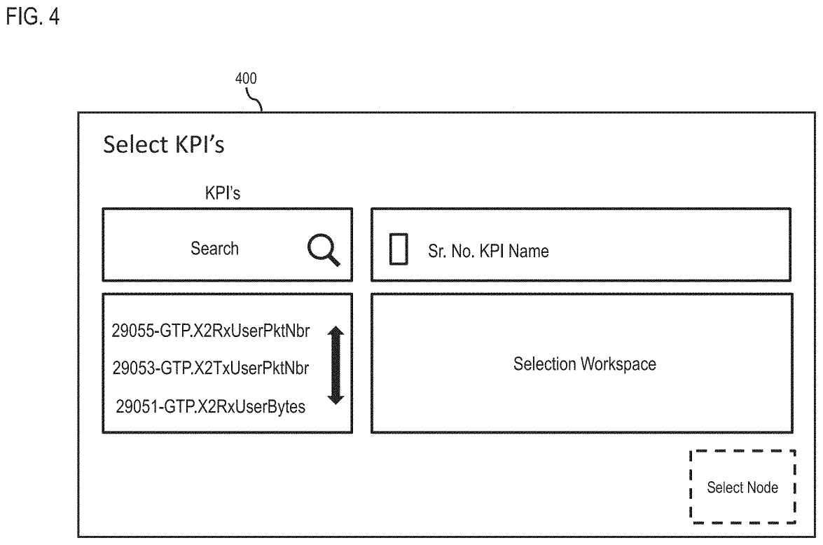

FIG. 4 is a diagram of a graphical user interface 400, in accordance with one or more embodiments. Graphical user interface 400 shows a KPI selection interface that enables a user to select target KPIs regarding the selected/inputted parameters for domain, network service provider, technology, equipment type, duration, etc. in user interface 300. In some embodiments, graphical user interface 400 is an example of a portion of user interface 200 (FIG. 2) and/or one of two or more screens of user interface 200.

In user interface 400, the user can select one or more target KPIs which are associated with the selected parameters associated with the target domain, network service provider, etc. FIG. 4 shows a situation wherein the user has not input anything to the search box. In some embodiments, the network management platform 101 is configured to cause some options of available KPIs to be shown. In some embodiments, those available KPIs that are shown are those that were most recently selected by the user, the most relevant to the domain and/or network service provider selected by the user, the most popular KPIs among similar users, or some other suitable preconfigurable basis for showing a limited example amount of the available KPIs.

In some embodiments, user interface 400 facilitate selecting the one or more target KPIs by way of a drag and drop operation to a selection workspace in the user interface. In some embodiment, the one or more target KPIs are selected by double clicking on the target KPIs, pressing a key on a keyboard, an interaction with a touch screen, clicking a check-box, or via some other suitable action. The selected target KPI(s) are then caused to appear in the selection workspace.

After selecting the target KPI(s), the user can, for example, click a “Select Node” button, or other suitable toggle such as “Next”, “Confirm”, hitting an enter key, a space bar, etc., to trigger a next portion of user interface 200 for selecting the node for the one or more selected target KPIs.

In some embodiments, the next portion of user interface 200 is presented in the same dashboard/window with a previous portion of user interface 200, such as by displaying additional input fields to facilitate selecting a node or other parameters that are viewable in the same screen or to enable the user to scroll down to access the next portion of user interface 200 after selecting the parameters in a previous portion of user interface 200. In some embodiments, a next portion of user interface 200 is provided in a subsequent view. If in a subsequent view, some embodiments enable a user to navigate back to a previous page or navigate forward to a next page.

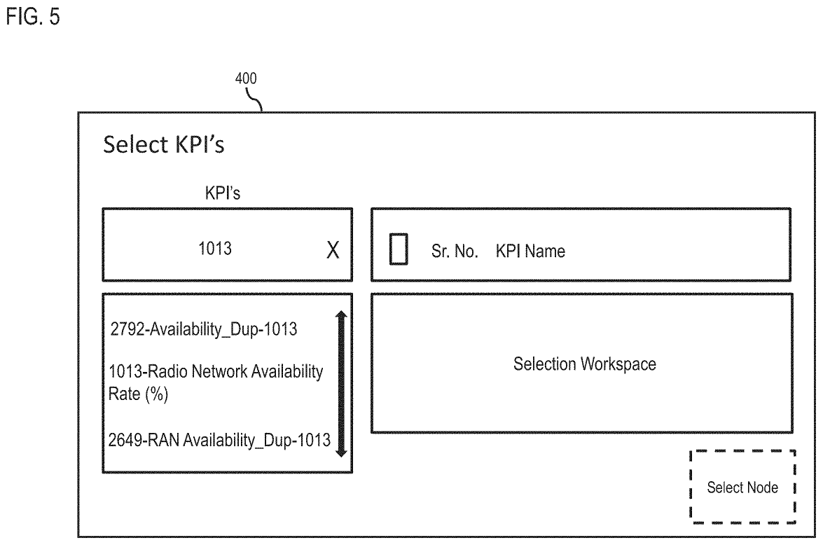

FIG. 5 is a diagram of a graphical user interface 400, in accordance with one or more embodiments. In FIG. 5, user interface 400 is shown having an example user input keyword of “1013” in the KPI input field. Based on the keyword entered into user input field, the network management platform 101 communicates with database 103, requests KPI data associated with the input keyword, and causes the associated KPI(s) to be presented to the user in a list form. In some embodiments, the order of the KPIs that are displayed is based on a user type, the KPIs search history, the popularity of KPIs, the importance of KPIs, or some other suitable basis.

In some embodiments, the one or more target KPIs are selected by way of a drag and drop operation to the selection workspace in the user interface. In some embodiment, the one or more target KPIs are selected by double clicking on the target KPIs, press a key on a keyboard, an interaction with a touch screen, clicking a check-box, or via some other suitable action.

After selecting the target KPI(s), the user can, for example, click the “Select Node” button, or other suitable toggle such as “Next”, “Confirm”, hitting an enter key, a space bar, etc., to trigger a next portion of user interface 200 for selecting the node for the one or more selected target KPIs.

In some embodiments, the next portion of user interface 200 is presented in the same dashboard/window with a previous portion of user interface 200, such as by displaying additional input fields to facilitate selecting a node or other parameters that are viewable in the same screen or to enable the user to scroll down to access the next portion of user interface 200 after selecting the parameters in a previous portion of user interface 200. In some embodiments, a next portion of user interface 200 is provided in a subsequent view. If in a subsequent view, some embodiments enable a user to navigate back to a previous page or navigate forward to a next page.

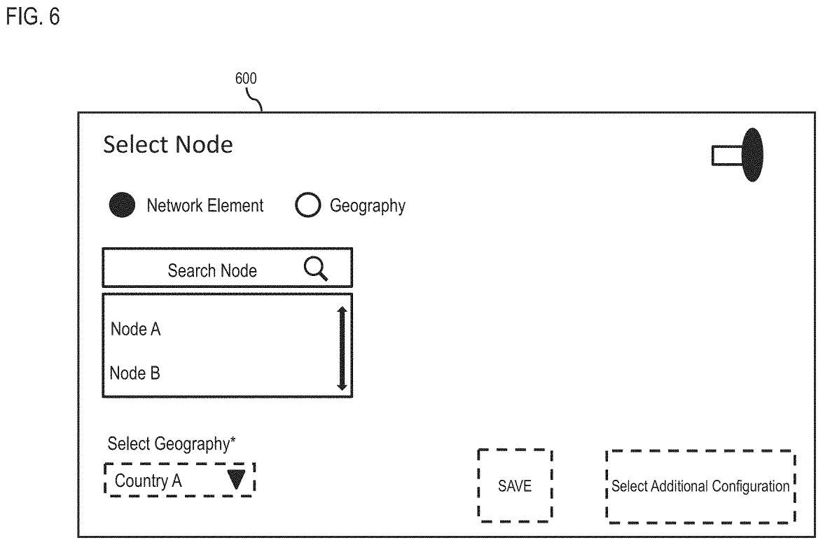

FIG. 6 is a diagram of a graphical user interface 600, in accordance with one or more embodiments. Graphical user interface 600 shows a node/geographical location selection interface. In some embodiments, graphical user interface 600 is an example of a portion of user interface 200 (FIG. 2) and/or one of two or more screens of user interface 200. In some embodiments, graphical user interface 600 is caused to be displayed by selecting “select node” in graphical user interface 400 (FIGS. 4 and 5).

In user interface 600, the user can select the node to which the selected target KPI(s) are corresponded. In some embodiments, the network management platform 101 causes the user interface 600 to provide two options: (1) specify the target node, or (2) select a group of nodes in a specific location. In some embodiments, a user may optionally input or select an available geographical region associated with the selected node(s) by inputting such information into a select geography input field. In some embodiments, the geographical region is based on a user's own knowledge and manually input. In some embodiments, the geographical region is based on the selected node(s) and made available for selection by way of a drop box, for example, based on associated KPI data and/or geographical regions stored in the database 103.

FIG. 6 shows an example in which the user has specified the target node by selecting “Network Element” and entering keywords in the input window. Similar to other input windows, the user can also select available options by triggering a drop-down list, or some other suitable action.

After selecting the node(s), user interface 600 facilitates saving the configuration by pressing a “Save” button on the user interface, by pressing Ctrl+S on a keyboard, by pressing Enter, by right-clicking a mouse and then selecting save option from a pop-out menu, or by some other suitable manner. Accordingly, the user selected/inputted parameters will be stored in database 103 as a generated evaluation profile. Alternatively, the user may optionally add additional configuration information to the evaluation profile by selection a “select additional configuration” button or other suitable user interface icon to proceed to another portion of user interface 200 to optionally input further parameters for defining the evaluation profile prior to saving the generated evaluation profile.

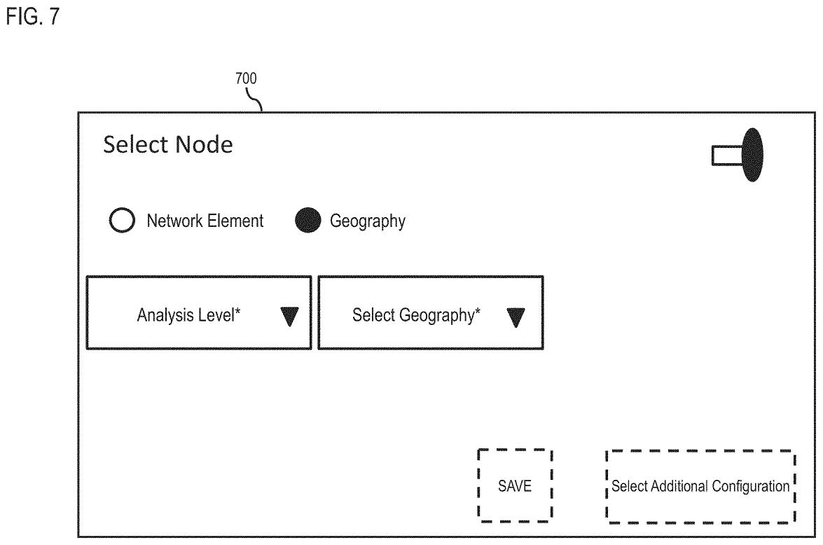

FIG. 7 is a diagram of graphical user interface 700, in accordance with one or more embodiments. Graphical user interface 700 shows the node/geographical location selection interface. In some embodiments, graphical user interface 700 is triggered by selecting “Geography” in graphical user interface 600 (FIG. 6). In some embodiments, graphical user interface 600 is triggered by selecting “Network Element” in graphical user interface 700. In some embodiments, graphical user interface 700 is caused to be displayed by selecting “select node” in graphical user interface 400 (FIGS. 4 and 5) and is displayed (instead of graphical user interface 600) following the selection of “select node” in graphical user interface 400.

FIG. 7 shows an example in which the user has selected the target node by selecting “Geography.” This option may be beneficial for a user that does not have information regarding a specific node or does not want to select a particular node, and helps to facilitate easy selection of a group of nodes in a selected location.

In some embodiments, selecting the geography option causes network management platform 101 to provide an analysis level input field wherein a user may select one or more of a country, region, prefecture, state, county, city, town, village, cluster, group center (GC), or some other suitable degree of geographical demarcation. In some embodiments, based on the input received for the analysis level input field, the network management platform 101 causes a selectable option corresponding to the input received by way of the analysis level input field such as, a country name, prefecture name, state name, city name, region name, town name, cluster name, etc. In some embodiments, user interface 700 facilitate manually inputting the analysis level and/or the selected geographical location into the analysis level input field and/or the select geography input field.

In some embodiments, user interface 700 facilitates selecting multiple locations at one time, such that multiple groups of nodes are selected for the target KPI(s).

After selecting the analysis level(s) and region(s), user interface 700 facilitates saving the configuration by pressing a “Save” button on the user interface, by pressing Ctrl+S on a keyboard, by pressing Enter, by right-clicking a mouse and then selecting save option from a pop-out menu, or by some other suitable manner. Accordingly, the user selected/inputted parameters will be stored in database 103 as a generated evaluation profile. Alternatively, the user may optionally add additional configuration information to the evaluation profile by selection a “select additional configuration” button or other suitable user interface icon to proceed to another portion of user interface 200 to optionally input further parameters for defining the evaluation profile prior to saving the generated evaluation profile.

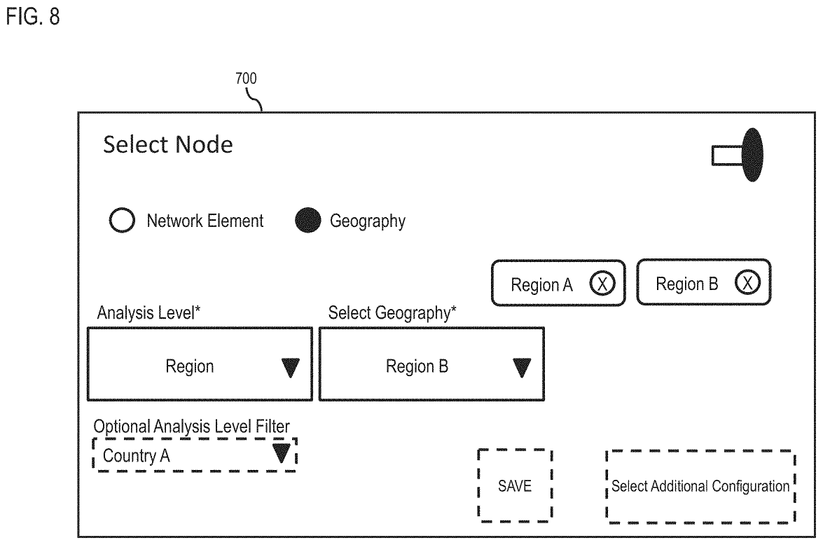

FIG. 8 is a diagram of graphical user interface 700, in accordance with one or more embodiments. FIG. 8 shows an example in which a user has selected “Region” as the “Analysis Level” and selected Region A and Region B as the target locations in user interface 700. In some embodiments, user interface 700 is caused to provide options for selecting the geographical location based on the selected analysis level and/or any data associated with the selected target KPIs based on data stored in database 103. In some embodiments, user interface 700 facilitates selecting an available geography by way of providing the options in a drop-down box and/or being configured to receive a user input by way of the select geography input field. In some embodiments, the available options included in the select geography input field are narrowed based on a user input received in the select geography input field included in user interface 600, such as a country name. In some embodiments, user interface 700 provides one or more options for selectively narrowing the available geographical locations based on the selected analysis level by providing an optional analysis level filter input field for a user input one or more parameters further defining the selected analysis level. For example, if a user selects “region” as the analysis level, the user interface 700 causes a first option for determining which of the available regions are to be provided for selection to a user in the select geography input field. For example, if a user selects “region” and then optionally adds “Country A”, the select geography input field will provide options for selectable regions in the identified Country A.

After selecting the analysis level(s) and region(s), user interface 700 facilitates saving the configuration by pressing a “Save” button on the user interface, by pressing Ctrl+S on a keyboard, by pressing Enter, by right-clicking a mouse and then selecting save option from a pop-out menu, or by some other suitable manner. Accordingly, the user selected/inputted parameters will be stored in database 103 as a generated evaluation profile. Alternatively, the user may optionally add additional configuration information to the evaluation profile by selection a “select additional configuration” button or other suitable user interface icon to proceed to another portion of user interface 200 to optionally input further parameters for defining the evaluation profile prior to saving the generated evaluation profile.

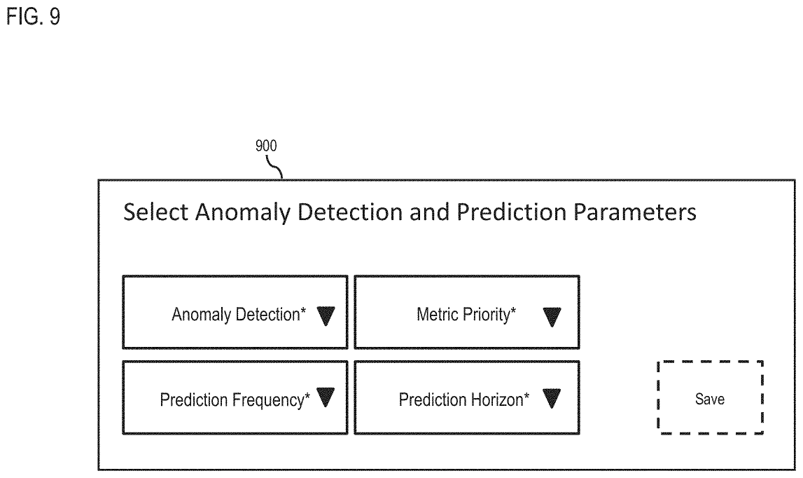

FIG. 9 is a diagram of graphical user interface 900, in accordance with one or more embodiments. In user interface 900, the user can select the parameters that configure the anomaly detection and prediction. In some embodiments, graphical user interface 900 is an example of a portion of user interface 200 (FIG. 2) and/or one of two or more screens of user interface 200. In some embodiments, FIG. 9 is an optional user interface which will only be presented to a user if the user would like to specify parameters for anomaly detection and prediction.

The input windows of “Anomaly Direction” and “Metric Priority” (which is optional) is related to parameters for anomaly detection; and the input windows of “Prediction Horizon” and “Prediction Frequency” (which is optional) is related to KPI data prediction and anomaly prediction in the predicted KPI data.

The selectable parameters for “Anomaly Direction”, in this example, are: Up, Down, Equal, Both, which refers to the definition of “Anomaly” as compared to one or more corresponding thresholds. For example, if “Up” is selected, the network management platform 101 will determine that an anomaly has occurred when the KPI data is above a corresponding threshold(s) at a particular time point.

The parameters for “Metric Priority” is optional. These parameters determine which of the selected KPIs the network management platform 101 is to prioritize. For example, if network management platform 101 detects, based on a user's information, that one or more KPIs are selected by a VIP user or a super-admin user, the network management platform 101 gives higher priority in monitoring, detecting, and predicting anomaly in the selected KPI(s).

The parameters for “Prediction Horizon” determine how many times the network management platform 101 is to predict the selected KPI(s) after the latest historical KPI data (e.g., if 125 is selected, 125 data points from the latest KPI data will be predicted).

The parameters for “Prediction Frequency” is optional. These parameters determine the prediction priority, and how frequent the prediction is to be performed. These parameters can be associated with “Metric Priority”, e.g., for KPI(s) selected by a high priority user, the prediction can be performed more frequently.

After selecting the parameters, user interface 900 facilitates saving the configuration by pressing a “Save” button on the user interface, by pressing Ctrl+S on a keyboard, by pressing Enter, by right-clicking a mouse and then selecting save option from a pop-out menu, or by some other suitable manner. Accordingly, the user selected/inputted parameters will be stored in database 103 as a generated evaluation profile.

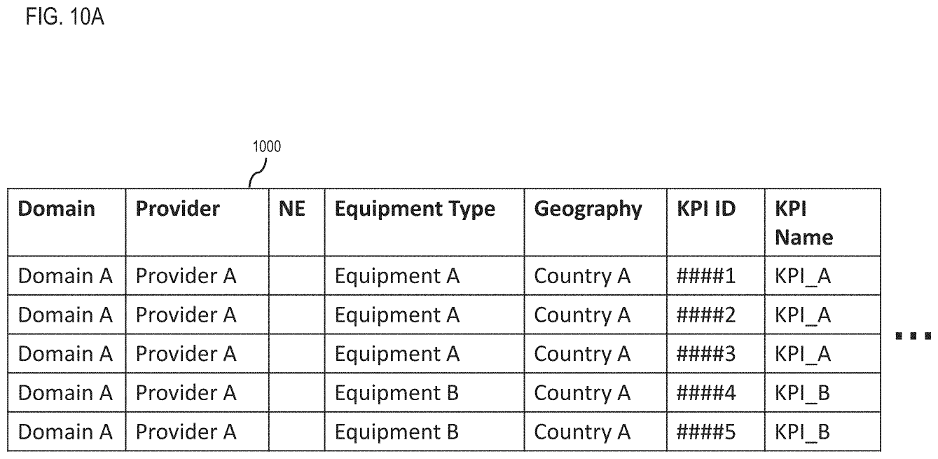

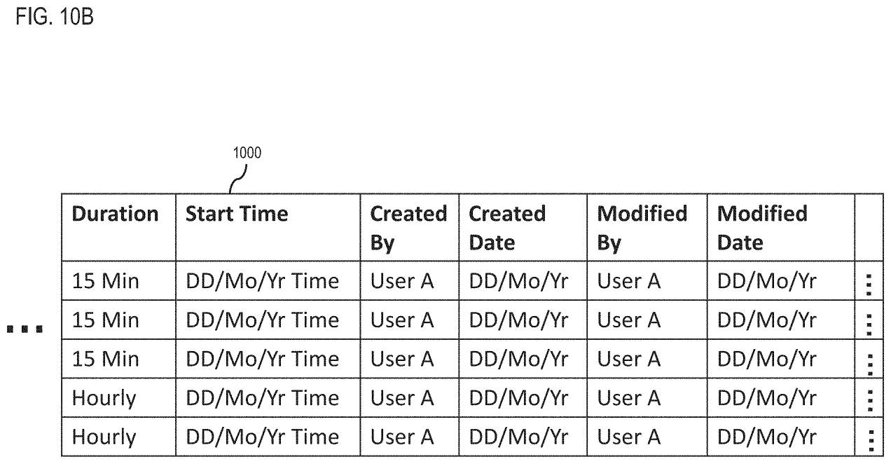

FIGS. 10A and 10B are diagrams of graphical user interface 1000, in accordance with one or more embodiments. In some embodiments, based on the quantity and/or width of columns in user interface 1000, the user interface 1000 is capable of being scrolled horizontally, and based on the quantity and/or height of the rows in user interface 1000, the user interface 1000 is capable of being scrolled vertically. For example, user interface 1000 makes it possible to view the columns shown in FIG. 10A and the columns shown in FIG. 10B by scrolling in a horizontal direction to and from the views shown in FIGS. 10A and 10B.

User interface 1000 is an example list of evaluation profiles saved in database 103 for a user corresponding to the evaluation profiles included in the list shown in user interface 1000, or a user having authorization to view the list of evaluation profiles based on the user credentials received by way of user interface 200 (FIG. 2).

The list comprises information associated with the user's selected KPIs, such as Domain, Provider, Network Element, Equipment Type, Geography, KPI ID, Duration (for presenting the KPI), Start Time, Created By (e.g., User Name), Created Date, Modified Date, Modified By (e.g., User Name), etc. In some embodiments, the information is stored in a single list, so as to provide a comprehensive presentation of evaluation profile information that is viewable by scrolling through the display. In some embodiments, the list is broken into multiple sub-windows that are optionally selectable to cause more detail to be presented via user interface 1000, or by way of some other suitable manner.

In some embodiments, once the profiles are created, the network management platform 101 automatically monitors the target KPI(s) defined in the profiles, and causes an action (e.g., sending an alert to a user, perform a network function, etc.) based on a detected active anomaly or a predicted anomaly in the selected target KPI(s).

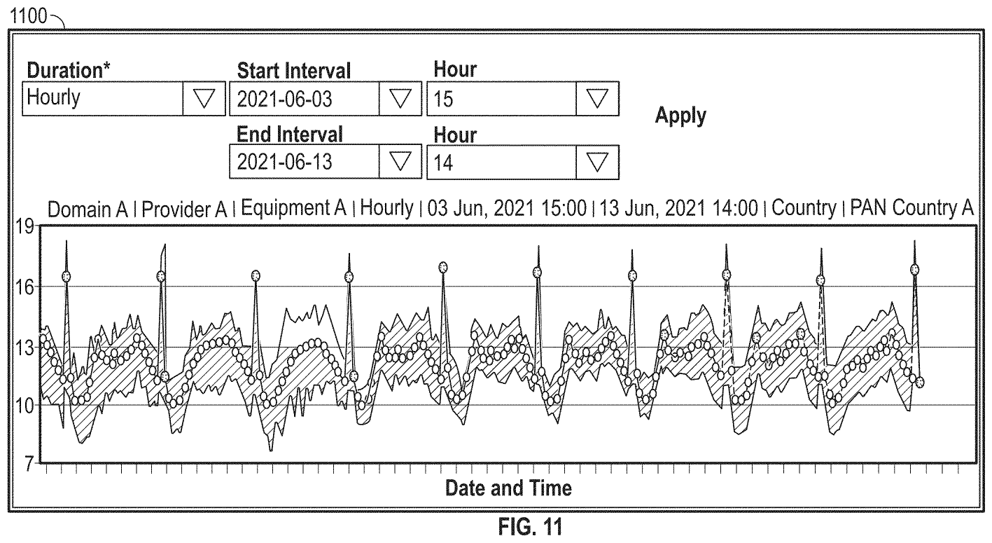

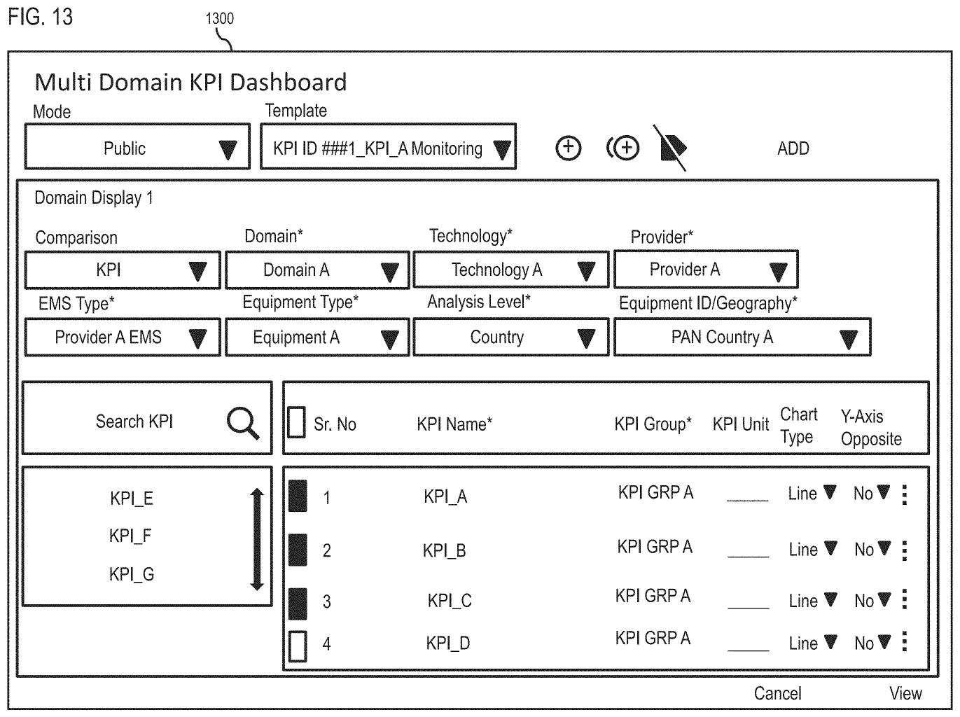

Meanwhile, network management platform 101 makes it possible for a user to choose to view KPIs in a real-time process by, for example, selecting one or more of the profiles included in the presented list. In some embodiments, the user may select one of the profiles included in the presented list (e.g., by double clicking the desired profile) and the network management platform 101 will generate and present a graphical representation of KPI prediction and anomaly detection for the selected profile (as depicted in FIGS. 11 and/or 12). Alternatively, in some embodiments, instead of immediately viewing the graphical representation(s) shown in FIGS. 11 and/or 12, selecting one or more of the profiles included in the graphical user interface 1000 triggers another graphical user interface to select and/or configure presentation of one or more KPIs associated with the selected one or more profiles (as depicted in FIGS. 13 and/or 14).

FIG. 11 is a diagram of graphical user interface 1100, in accordance with one or more embodiments. User interface 1100 is a graphical representation of KPI prediction and anomaly detection in real-time. In this example, the user configured and selected an evaluation profile (e.g., via graphical user interfaces as discussed with respect to FIGS. 2-10) of:

Domain: Domain A

Provider: Provider A

Equipment Type: Equipment A

Duration: Hourly

KPI: KPI_A

Node: Analysis level—Country, Geography—Personal Area Network (PAN) in Country A

Anomaly Direction: Both

Prediction Horizon: 58

User interface 1100 is triggered, for example, by selecting one of the profiles included in the presented list shown in user interface 1000 (FIG. 10), by double clicking the desired profile, selecting a view option, or some other suitable action, that causes the network management platform 101 to generate and present the graphical representation of KPI prediction and anomaly detection for the selected profile shown in user interface 1100.

User interface 1100 provides a graphical representation of KPI prediction and anomaly prediction with confidence bands formed by an upper threshold and a lower threshold. In some embodiments, the confidence bands are dynamic values that vary over time, providing upper and lower threshold values. In this example, the confidence band is shown in user interface 1100 as a shaded portion demonstrating the upper and lower threshold values within which the KPI being viewed should be if the KPI is considered to be normal.

In this example, since “Both” was selected as the “Anomaly Direction” in the evaluation profile, as discussed above, once the network management platform 101 detects that the KPI data falls outside of the confidence band (i.e., higher than the upper threshold or lower than the lower threshold) at a time point, the network management platform 101 determines that an anomaly occurs in the KPI data at the particular time point.

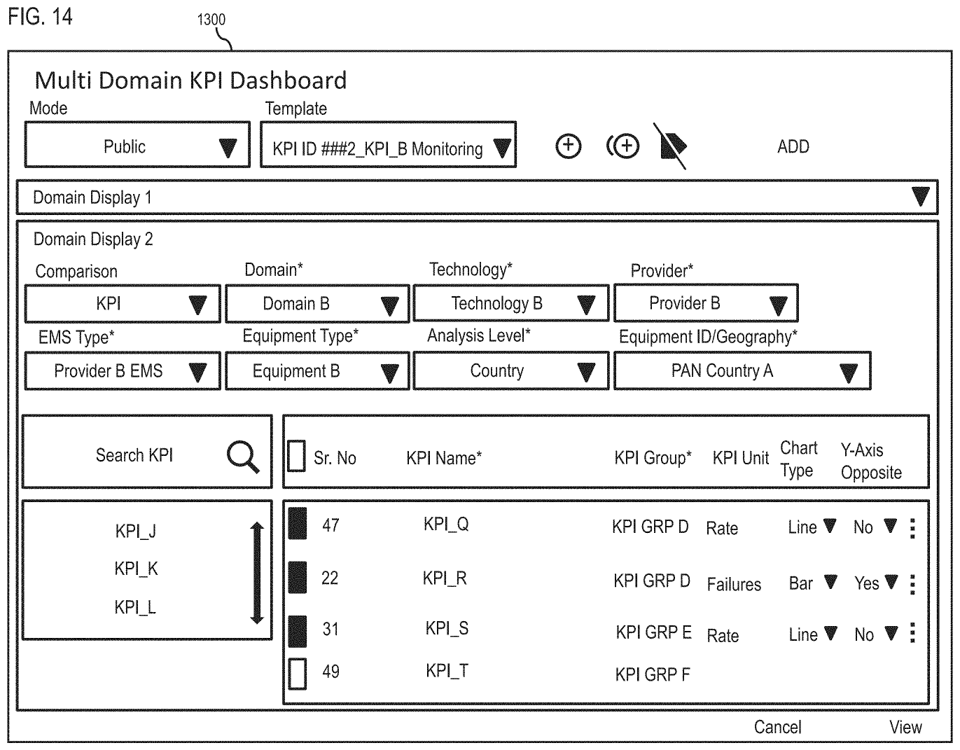

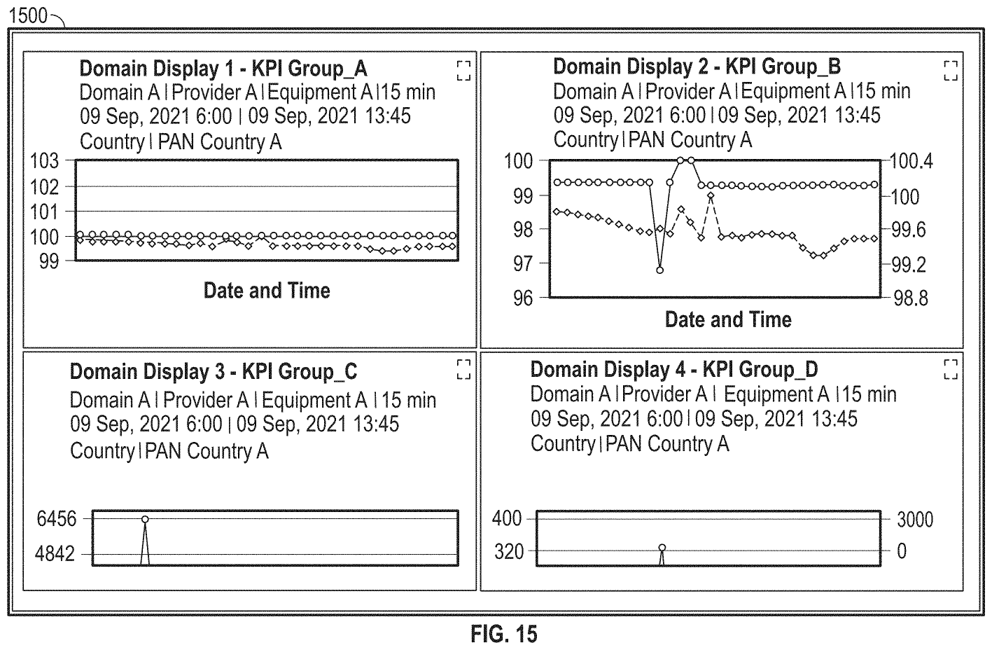

In various embodiments, the user interface 200 (FIG. 2) provides interfaces to enable the user to freely configure how the process is to be presented. In this example, since the “Hourly” was selected as “Duration” in the configuration profile, the process will be initially presented in hourly-based. In this example, the user selected “15:00” of “2021-06-03” as the starting time and “14:00” of “2021-06-13” as the ending time. Thus, the network management platform 101 generates the graphical representation and monitors the KPI data from 15:00 of 2021-06-03 to 14:00 of 2021-06-13 on an hourly basis. In some embodiments, network management platform 101 is configured to allow a user to re-configure (e.g., via user interface 1100, and/or the user interfaces discussed with respect to FIGS. 14 and 15) the “Duration” to be some other suitable parameter, such as “Daily”, “Weekly”, “Monthly”, “Yearly”, etc., and to re-configure the starting time and ending time accordingly.

If the network management platform 101 detects that an anomaly has occurred in the historical KPI data at a particular time point, the network management platform 101 causes the portion of the graphical representation to be displayed differently from other portions of the graphical representation of the KPI data. For example, a normal portion of the KPI data may be displayed in blue or a solid line, whereas a portion of the KPI data that is in an anomalous condition may be presented in a red, in a dashed or dotted line, or in some other suitable format to distinguish a non-anomalous KPI data from anomalous KPI data.

When presenting the latest KPI data, the network management platform 101 predicts KPI data in accordance with the selected “Prediction Horizon”. In the examples discussed above, the last KPI is presented at 15:00 of 2021-06-13, and the “Prediction Horizon” is selected as 58. Thus, from 15:00 of 2021-06-13, the network management platform 101 will predict KPI data for the next 58 data points (i.e., for the next 58 hours in this example). The prediction may be based on a recent trend in the historical KPI data, the recent KPI data at the similar time point (e.g., for 14:00 of 2021-06-13, 15:00 of 2021-06-09, 15:00 of 2021-06-08, and the like may be considered as the recent KPI data at a similar time point), the KPI data at the similar time point from other location, etc.

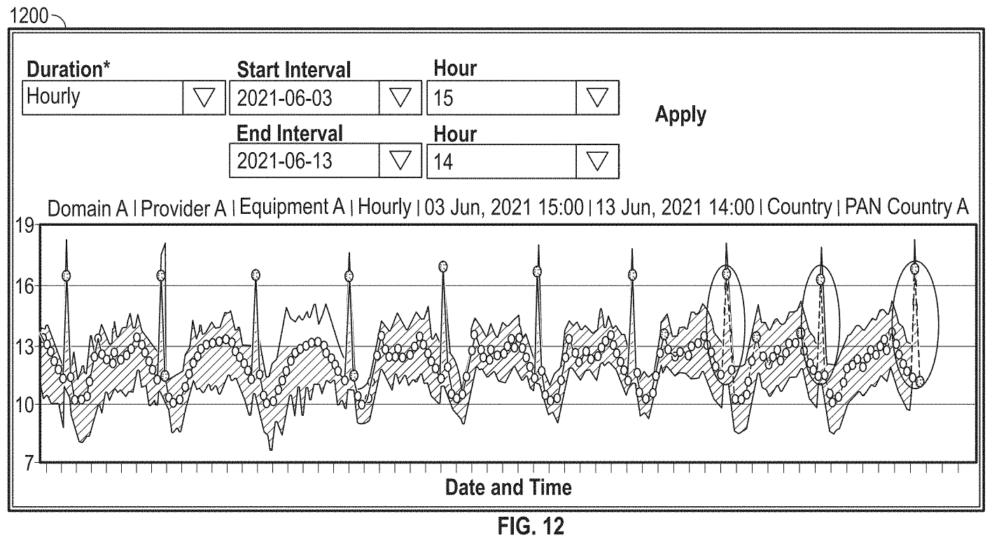

FIG. 12 is a diagram of graphical user interface 1200, in accordance with one or more embodiments. FIG. 12 is similar to the graphical representation of the KPI data shown in user interface 1100 and discussed with respect to FIG. 11. In user interface 1200, after the KPI data has been predicted, the network management platform 101 determines whether any of the predicted KPI data falls outside of the confidence band. If it is determined that the predicted KPI data falls outside of the confidence band (i.e., higher than the upper threshold or lower than the lower threshold) at a time point, the network management platform 101 determines that an anomaly occurs in the predicted KPI data at the particular time point. In some embodiments, to distinguish the anomaly detected in the historical KPI data and the anomaly detected in the predicted KPI data, the anomaly detected in the predicted KPI data is presented in dotted-yellow-lines, or some other suitable distinguisher as illustrated in the circled portions in FIG. 12. In some embodiments, the network management platform 101 causes the detected anomalous portions in the predicted KPI data to be circled to make the anomaly even more clearly identifiable to a user viewing the graphical representation of the KPI data shown in user interface 1200.

In some embodiments, instead of providing input windows for inputting starting time and ending time as illustrated in FIGS. 11 and 12, user interface 200 (or portion thereof such as user interface 300 or other suitable portion) includes an input field requesting the user to input the desire time interval (e.g., 30 minutes, 20 hours, 3 days, 4 weeks, 2 years, etc.). Accordingly, the network management platform 101 causes the KPI data to be presented based on the selected time interval, and then predicts KPI data based on the “Prediction Horizon” defined by the evaluation profile.

For example, if the user selects 20 hours as the desired time interval and the “Prediction Horizon” is selected as 24, the network management platform 101 presents the historical KPI data of the past 20 hours from the current hour, detects the anomaly, and predicts missing KPI data for the historical KPI data. Then, the network management platform 101 predicts KPI data for the next 24 hours and detects anomalies in the predicted KPI data. After an hour, the KPI data of the previously current hour will be the new historical KPI data, and the network management platform 101 will continue to cause a new set of historical KPI data of the past 20 hours to be presented from the new current hour, and then predict KPI data for the next 24 hours from the new current hour. Accordingly, the network management platform 101 dynamically monitors the KPI data, predicts KPI data, and detects anomalies in the KPI data and predicted KPI data, based on the evaluation profile so as to predict KPI data and/or predict anomalies in the KPI data in real-time.

In some embodiments, user interface 200 (or portion thereof such as user interface 300 or other suitable portion) can include an input field for inputting a start time and an input field for inputting a time interval to schedule a dynamic KPI monitoring and anomaly detection and prediction for the future.

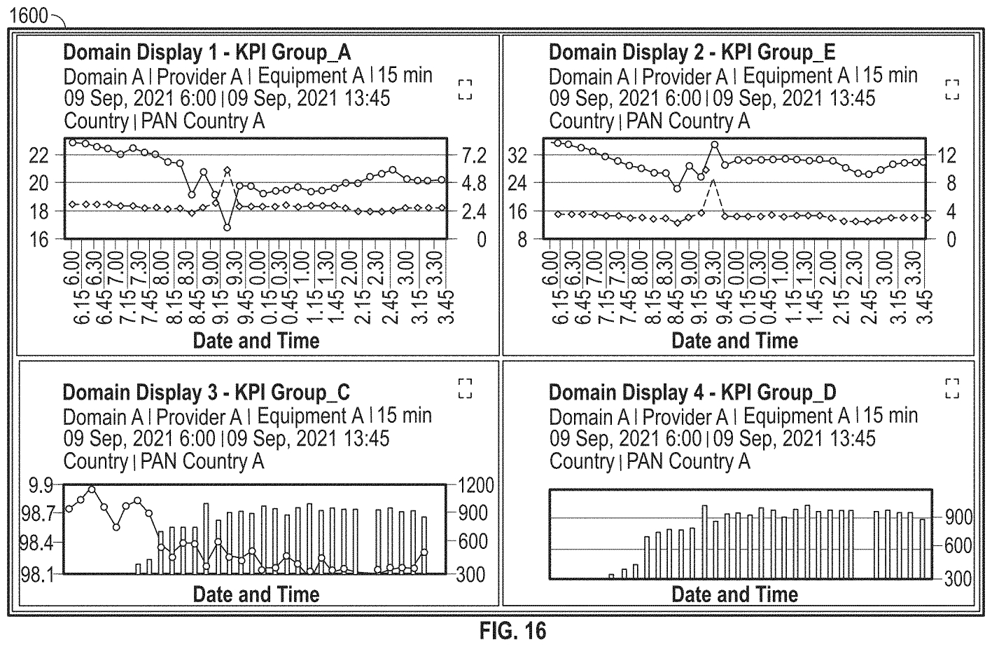

FIG. 13 is a diagram of graphical user interface 1300, in accordance with one or more embodiments. User interface 1300 is an example display for selecting and monitoring multiple KPIs of a network service provider for monitoring in a single dashboard/window. In some embodiments, the user may, for example, select one or more of the created evaluation profiles in user interface 1000, as discussed above, by way of double clicking, selecting and hitting enter, clicking on three dots at the end of a row in the list of evaluation profiles, or by way of some other suitable action. The network management platform 101 then causes user interface 1300 to be presented. In some embodiments, the network management platform 101 causes the KPI(s) associated with the selected evaluation profile to be included in the selection workspace. In some embodiments, a user may choose to view the KPI(s) included in the selection workspace by selecting “view”, which triggers a graphical representation of the KPI(s) by way of user interface 1600 (FIG. 16), for example. User interface 1300 also makes it possible to add and/or delete KPI(s) to/from the selection workspace. In some embodiments, a user may search for available KPIs in a manner similar to that discussed with respect to FIGS. 4 and 5 regarding user interface 400. In some embodiments, the user may input keywords to search for KPI(s) that may be added to the selection workspace. In some embodiments, the network management platform 101 is configured to limit the available KPIs to those associated with the selected KPI from user interface 1000, for example, based on the associated network service provider, units, time range, etc. In some embodiments, the network management platform 101 automatically collects and presents all related KPIs to the user in one display within which the user may scroll to find KPIs the user would like to add to the selection workspace. The user may, for example, populate the selection workspace by dragging and dropping KPIs from the list of KPIs, double clicking on the KPI included in the list of KPIs, or by some other suitable action.

In this example, user interface 1300 shows multiple KPIs related to Equipment A (e.g, eNodeB, or some other suitable network element or type of equipment) of Provider A (i.e., one of the network service providers) after the user selected an evaluation profile which is related to Equipment A of Provider A.

User interface 1300 makes it possible for a user to select which KPIs are to be monitored by, for example, clicking a check-box beside each selected KPI that is added to the selection workspace. After selecting the desired KPI(s), the user interface 1300 provides a selectable “View” option, or some other suitable method to trigger a next operation. The network management platform 101 then processes the evaluation profile(s) associated with the selected KPI(s), retrieves data of the selected KPI(s) from the database 103 based on the respective evaluation profile, generates a graphical representation (e.g., graph, histogram, etc.) for the selected KPI(s) based on the retrieved data and the evaluation profile, and then presents the graphical representation of the selected KPIs on a single dashboard/window.

In this example, the user has populated the selection workspace with four KPIs, KPI_A, KPI_B, KPI_C, and KPI_D. Each of the four KPIs that are included in selection workspace are associated with KPI Group_A. A KPI Group may be associated with types of KPIs that are being monitored such as accessibility, setup failures, mobility, sector throughput, user throughput, drop rate, or other suitable category. The user has selected KPI_A, KPI_B, and KPI_C from those included in the selection workspace for inclusion in the graphical representation that is to be generated based on the parameters being entered into user interface 1300. Each of the KPI_A, KPI_B, and KPI_C, in this example, are to be included in a single graphical representation within user interface 1500. In this example, the user has input options for “Domain Display 1”, which could be referred to as some other suitable name, so that the user may view multiple KPIs in relation to one another within a single graph. User interface 1300 also makes it possible to add further “Domain Displays” such as “Domain Display 2” (see FIGS. 14 and 15), within which the user may view graphical representation(s) of additional or alternative KPI(s) that are to be included in a single graph within user interface 1500, for example. In some embodiments, user interface 1300 makes it possible to add additional Domain Displays based on any of the selected parameters available in user interface 1300. For example, a user may add KPIs that are associated with different combinations of KPI types, domains, technologies, network service providers, messaging types, equipment types, analysis level, etc.

User interface 1300 facilitates customizing how a KPI is to be presented in the graphical representation. For example, a user may select to create a line graph, a bar graph, or some other suitable representation type, and/or which side of the graph is to include the units. For example, KPI_A may be a percentage, with values to be shown on the left side of the y-axis in a graphical representation, and KPI_B may be a quantity of drops that is to be plotted based on units shown on the right side, or opposite y-axis of the graphical representation. In this way, KPIs that have different units may be included in a single graphical display over a period of time. (e.g., see FIG. 15, Domain Display 2, which has different values on each side of the graph for different KPIs that are shown as being plotted over time in the x-axis.

FIG. 14 is a diagram of graphical user interface 1300, in accordance with one or more embodiments. User interface 1300, in this example, shows the evaluation profile configuration interface being used for monitoring multiple KPIs of multiple network service providers in a single dashboard/window.

In user interface 1300, the user can add an evaluation profile associated with another network service provider (e.g., by clicking another configuration profile on the list, by drag-and-drop another configured evaluation profile into a workspace of the user interface, etc.). In this example, an evaluation profile of Domain B (e.g., core) of Provider B (i.e., another network service provider) is added to Domain Display 2, which is to be concurrently shown with whatever KPIs have been added to Domain Display 1 in this example of user interface 1300.

By selecting one or more KPIs across different combinations of domains, network service providers, etc., user interface 1300 makes it possible for a user to easily view different graphical representations of multiple KPIs for different service providers in one graphical view, such as by configuring KPIs for different service providers to appear in one Domain Display, or by configuring KPIs for different service providers to appear in separate Domain Displays that are concurrently displayed in one user interface screen. In this example, the selected KPIs for each of Domain Display 1 and Domain Display 2 would be caused to appear in separate portions of a user interface screen such as user interface 1600 (FIG. 16), for example.

FIG. 15 is a diagram of graphical user interface 1500, in accordance with one or more embodiments. User interface 1500 is an example displayed graphical representation of KPIs related to Equipment A (e.g., eNodeB) of Provider A for different KPI Groups as setup by way of user interface 1300, for example, creating different Domain Displays (i.e., at least Domain Display 1, Domain Display 2, Domain Display 3, Domain Display 4) for KPI Group_A, KPI Group_B, KPI_Group_C, KPI Group_D (e.g., Accessibility, Availability-Accessibility, Setup Failures, Mobility, etc). In addition to the above, the user can also select and monitor other KPIs on the same dashboard/window, e.g., KPIs from another domain, and scroll through the user interface 1500 to view additional Domain Displays if any are instructed to be added to the graphical representations included in this example of user interface 1500.

FIG. 16 is a diagram of graphical user interface 1600, in accordance with one or more embodiments. User interface 1600 is an example display including graphical representations of multiple KPIs of multiple network service providers in one dashboard/window.

In this example of user interface 1600, graphical representations of KPIs from multiple domains Domain A and Domain B (e.g., eNodeB and Core) and multiple network service providers Provider A and Provider B are presented on the same dashboard/window.

In some embodiments, the user interface 1600, for example, enables the user to freely select multiple KPIs from any domain, network service provider, technology, node, location, etc., and the network management platform 101 is configured to cause the graphical representation of said multiple KPIs on the same dashboard/window, in a similar manner to that discussed above.

In some embodiments, once the graphical representation of the multiple KPIs are presented, the network management platform 101 will, based on the respective evaluation profile, continuously retrieve the latest KPIs data from the database 103 and then update the graphical representation so as to collectively monitor multiple KPIs in real-time. In some embodiments, the user interface 1600 enables the user to freely select multiple KPIs as discussed above and the network management platform 101 is configured to cause the graphical representation of multiple KPIs prediction and anomaly detection on the same dashboard/window, in a similar manner to that discussed in accordance to FIGS. 11 to 12 and FIGS. 15 to 16.

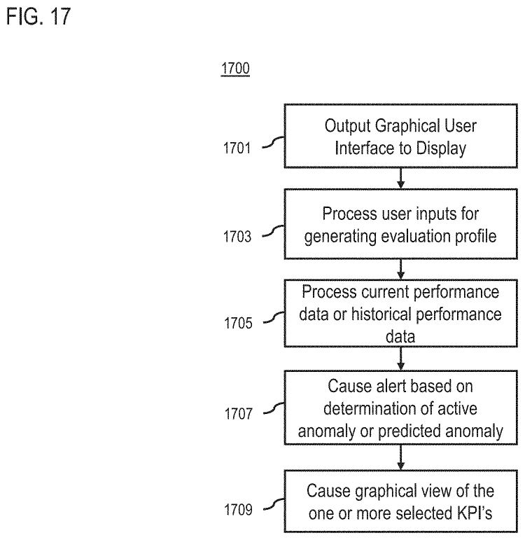

FIG. 17 is a flowchart of a process 1700 for monitoring one or more KPIs, predicting one or more KPIs, detecting anomalies in one or more KPIs and/or predicting anomalies in one or more KPIs, in accordance with one or more embodiments. In some embodiments, the network management platform 101 (FIG. 1) performs the process 1700.

In step 1701, the network management platform 101 causes an evaluation profile user interface to be output by a display. The evaluation profile user interface comprises a key performance indicator (KPI) input field configured to receive a first user input identifying one or more selected KPIs of a plurality of available KPIs. Each KPI of the plurality of available KPIs is indicative of a corresponding operating state of a communication network. In some embodiments, a quantity of the one or more selected KPIs is less than a total quantity of the plurality of available KPIs, and the quantity of the one or more selected KPIs is less than or equal to a preset number based on a user credential associated with a user to which a configured evaluation profile is assigned. In some embodiments, the user credential indicates the user to which the configured evaluation profile is assigned is a first user having a first access-level type or a second user having a second access-level type corresponding to a higher level of admin rights than the first access-level type within a system for monitoring the one or more selected KPIs, and the preset number based on the user credential is greater for the second user than the first user.

The evaluation profile user interface also comprises one or more parameter input fields configured to receive one or more additional user inputs identifying at least one of a selected wireless domain of a plurality of wireless domains, a selected service provider of a plurality of service providers associated with providing a network service to the communication network, a selected wireless technology of a plurality of wireless technologies associated with the network service, a selected time interval for monitoring the one or more selected KPIs based on performance data related to the network service, a geographical location within which the network service is provided, or at least one network device by which the network service is provided.

In some embodiments, the selected time interval for monitoring the one or more selected KPIs extends from a start time before a time the configured evaluation profile is generated to an end time after the time the configured evaluation profile is generated. In some embodiments, the selected time interval for monitoring the one or more selected KPIs extends from a start time after a time the configured evaluation profile is generated to an end time after the start time. In some embodiments, the selected time interval indicates a start time before the evaluation profile is generated or a start time after the evaluation profile is generated, based on a user input, and an unbounded end time after the start time such that the KPIs are monitored continuously and/or in perpetuity until the monitoring is otherwise deactivated.

The evaluation profile user interface also includes one or more evaluation input fields configured to receive one or more anomaly detection instructions based upon which the one or more selected KPIs are processed to determine an anomalous condition of the one or more selected KPIs. The one or more evaluation input fields comprise an option to select at least one of an active anomaly for detecting an instance of the one or more selected KPIs being outside of an expected range based on current performance data received from at least one selected service provider or the at least one network device as the current performance data is received, or a predicted anomaly for detecting a forecast deviation of the one or more selected KPIs from the expected range based on a projected KPI value for at least one of the one or more selected KPIs determined based on historical performance data and a future time period indicated by way of one or more of the anomaly instructions.

In some embodiments, the one or more evaluation input fields further comprises a threshold comparison parameter indicating a basis upon which the active anomaly or the predicted anomaly is determined.

In some embodiments, the threshold comparison parameter is one of greater than or less than a baseline threshold value, and the active anomaly or the predicted anomaly is determined based on an actual breach or a predicted breach of the baseline threshold value in accordance with the threshold comparison parameter.

In some embodiments, the threshold comparison parameter is a confidence band defining a range of a maximum threshold value and a minimum threshold value, and the active anomaly or the predicted anomaly is determined based on an actual breach or a predicted breach of the maximum threshold value or the minimum threshold value in accordance with the threshold comparison parameter.

In some embodiments, the threshold comparison parameter defines a tolerance range of change over time for the selected one or more KPIs, and the active anomaly or the predicted anomaly is determined based on an actual breach or a predicted breach of the tolerance range of change over time, indicating a trend of reduced quality of the network service, in accordance with the threshold comparison parameter.

In step 1703, the network management platform 101 processes the first user input, the one or more additional user inputs and the one or more anomaly detection instructions to generate the configured evaluation profile.

In step 1705, the network management platform 101 processes at least one of the received current performance data or the historical performance data based on the configured evaluation profile.

In step 1707, the network management platform 101 causes an alert to be output to a network operator of the communication network based on a determination that the received performance data or the historical performance data indicates the active anomaly or the predicted anomaly.

In step 1709, the network management platform 101 causes a graphical view of the one or more selected KPIs over time to be output by the display based on an instruction to monitor the one or more selected KPIs. In some embodiments, based on a determination that two or more selected KPIs are indicated based on the first user input, the two or more selected KPIs are caused to be simultaneously included in the graphical view.

The discussed embodiments provide a system and method which allows a user to select one or more KPIs from multiple network service providers, multiple domains, multiple technologies, multiple locations, etc., and then detect and/or predict anomalous conditions in the selected KPIs in the user's desired manner. Further, the discussed embodiments provide a system and method which allows the user to customize the detection and/or prediction of anomaly of one or more KPIs at one time in individual evaluation profiles or combined evaluation profiles that include multiple KPIs and/or combination of evaluation profiles that are each associated with monitoring one or more selected KPIs. In some embodiments, the discussed system and method allow multiple users to customize the detection and/or prediction of anomaly of one or more KPIs at one time. Furthermore, the discussed embodiments provide a system and method capable of simultaneously detecting, predicting, and presenting multiple KPIs and the anomaly therein in one screen (e.g., in one dashboard, in one display of a Graphic User Interface, etc.). In some embodiments, the discussed system and method are capable of being set to automatically and continuously detect and/or predict anomaly of target KPIs based on the user's preference.

FIG. 18 is a functional block diagram of a computer or processor-based system 1800 upon which or by which an embodiment is implemented.

Processor-based system 1800 is programmed to facilitate monitoring one or more KPIs, predicting one or more KPIs, detecting anomalies in or more KPIs and/or predicting anomalies in one or more KPIs, as described herein, and includes, for example, bus 1801, processor 1803, and memory 1805 components.

In some embodiments, the processor-based system is implemented as a single “system on a chip.” Processor-based system 1800, or a portion thereof, constitutes a mechanism for performing one or more steps of facilitating monitoring one or more KPIs, predicting one or more KPIs, detecting anomalies in or more KPIs and/or predicting anomalies in one or more KPIs.

In some embodiments, the processor-based system 1800 includes a communication mechanism such as bus 1801 for transferring and/or receiving information and/or instructions among the components of the processor-based system 1800. Processor 1803 is connected to the bus 1801 to obtain instructions for execution and process information stored in, for example, the memory 1805. In some embodiments, the processor 1803 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of the processor 1803. Similarly, an ASIC is configurable to perform specialized functions not easily performed by a more general purpose processor. Other specialized components to aid in performing the functions described herein optionally include one or more field programmable gate arrays (FPGA), one or more controllers, or one or more other special-purpose computer chips.

In one or more embodiments, the processor (or multiple processors) 1803 performs a set of operations on information as specified by a set of instructions stored in memory 1805 related to facilitating monitoring one or more KPIs, predicting one or more KPIs, detecting anomalies in or more KPIs and/or predicting anomalies in one or more KPIs. The execution of the instructions causes the processor to perform specified functions.

The processor 1803 and accompanying components are connected to the memory 1805 via the bus 1801. The memory 1805 includes one or more of dynamic memory (e.g., RAM, magnetic disk, writable optical disk, etc.) and static memory (e.g., ROM, CD-ROM, etc.) for storing executable instructions that when executed perform the steps described herein to facilitate monitoring one or more KPIs, predicting one or more KPIs, detecting anomalies in or more KPIs and/or predicting anomalies in one or more KPIs. The memory 1805 also stores the data associated with or generated by the execution of the steps.

In one or more embodiments, the memory 1805, such as a random access memory (RAM) or any other dynamic storage device, stores information including processor instructions for monitoring one or more KPIs, predicting one or more KPIs, detecting anomalies in or more KPIs and/or predicting anomalies in one or more KPIs. Dynamic memory allows information stored therein to be changed. RAM allows a unit of information stored at a location called a memory address to be stored and retrieved independently of information at neighboring addresses. The memory 1805 is also used by the processor 1803 to store temporary values during execution of processor instructions. In various embodiments, the memory 1805 is a read only memory (ROM) or any other static storage device coupled to the bus 1801 for storing static information, including instructions, that is not capable of being changed by processor 1803. Some memory is composed of volatile storage that loses the information stored thereon when power is lost. In some embodiments, the memory 1805 is a non-volatile (persistent) storage device, such as a magnetic disk, optical disk or flash card, for storing information, including instructions, that persists even when the system 1800 is turned off or otherwise loses power.

The term “computer-readable medium” as used herein refers to any medium that participates in providing information to processor 1803, including instructions for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

An aspect of this description is related to a method, comprising causing, by a processor, an evaluation profile user interface to be output by a display. The evaluation profile user interface comprises a key performance indicator (KPI) input field configured to receive a first user input identifying one or more selected KPIs of a plurality of available KPIs. Each KPI of the plurality of available KPIs is indicative of a corresponding operating state of a communication network. A quantity of the one or more selected KPIs is less than a total quantity of the plurality of available KPIs. The quantity of the one or more selected KPIs is less than or equal to a preset number based on a user credential associated with a user to which a configured evaluation profile is assigned. The evaluation profile user interface also comprises one or more parameter input fields configured to receive one or more additional user inputs identifying at least one of a selected wireless domain of a plurality of wireless domains, a selected service provider of a plurality of service providers associated with providing a network service to the communication network, a selected wireless technology of a plurality of wireless technologies associated with the network service, a selected time interval for monitoring the one or more selected KPIs based on performance data related to the network service, a geographical location within which the network service is provided, or at least one network device by which the network service is provided. The evaluation profile user interface further comprises one or more evaluation input fields configured to receive one or more anomaly detection instructions based upon which the one or more selected KPIs are processed to determine an anomalous condition of the one or more selected KPIs. The one or more evaluation input fields comprise an option to select at least one of an active anomaly for detecting an instance of the one or more selected KPIs being outside of an expected range based on current performance data received from at least one selected service provider or the at least one network device as the current performance data is received, or a predicted anomaly for detecting a forecast deviation of one or more selected KPIs from the expected range based on a projected KPI value for at least one of the one or more selected KPIs determined based on historical performance data and a future time period indicated by way of one or more of the anomaly detection instructions. The method also comprises processing the first user input, the one or more additional user inputs and the one or more anomaly detection instructions to generate the configured evaluation profile. The method further comprises processing at least one of the received current performance data or the historical performance data based on the configured evaluation profile. The method additionally comprises causing an alert to be output to a network operator of the communication network based on a determination that the received current performance data or the historical performance data indicates the active anomaly or the predicted anomaly.

Another aspect of this description is related to an apparatus comprising a processor and a memory having instructions stored thereon that, when executed by the processor, cause the apparatus to cause an evaluation profile user interface to be output by a display. The evaluation profile user interface comprises a key performance indicator (KPI) input field configured to receive a first user input identifying one or more selected KPIs of a plurality of available KPIs. Each KPI of the plurality of available KPIs is indicative of a corresponding operating state of a communication network. A quantity of the one or more selected KPIs is less than a total quantity of the plurality of available KPIs. The quantity of the one or more selected KPIs is less than or equal to a preset number based on a user credential associated with a user to which a configured evaluation profile is assigned. The evaluation profile user interface also comprises one or more parameter input fields configured to receive one or more additional user inputs identifying at least one of a selected wireless domain of a plurality of wireless domains, a selected service provider of a plurality of service providers associated with providing a network service to the communication network, a selected wireless technology of a plurality of wireless technologies associated with the network service, a selected time interval for monitoring the one or more selected KPIs based on performance data related to the network service, a geographical location within which the network service is provided, or at least one network device by which the network service is provided. The evaluation profile user interface further comprises one or more evaluation input fields configured to receive one or more anomaly detection instructions based upon which the one or more selected KPIs are processed to determine an anomalous condition of the one or more selected KPIs. The one or more evaluation input fields comprise an option to select at least one of an active anomaly for detecting an instance of the one or more selected KPIs being outside of an expected range based on current performance data received from at least one selected service provider or the at least one network device as the current performance data is received, or a predicted anomaly for detecting a forecast deviation of the one or more selected KPIs from the expected range based on a projected KPI value for at least one of the one or more selected KPIs determined based on historical performance data and a future time period indicated by way of one or more of the anomaly detection instructions. The apparatus is also caused to process the first user input, the one or more additional user inputs and the one or more anomaly detection instructions to generate the configured evaluation profile. The apparatus is further caused to process at least one of the received current performance data or the historical performance data based on the configured evaluation profile. The apparatus is additionally caused to cause an alert to be output to a network operator of the communication network based on a determination that the received current performance data or the historical performance data indicates the active anomaly or the predicted anomaly.

Another aspect of this description is directed to a non-transitory computer readable medium having instructions stored thereon that, when executed by a processor, cause an apparatus to cause an evaluation profile user interface to be output by a display. The evaluation profile user interface comprises a key performance indicator (KPI) input field configured to receive a first user input identifying one or more selected KPIs of a plurality of available KPIs. Each KPI of the plurality of available KPIs is indicative of a corresponding operating state of a communication network. A quantity of the one or more selected KPIs is less than a total quantity of the plurality of available KPIs. The quantity of the one or more selected KPIs is less than or equal to a preset number based on a user credential associated with a user to which a configured evaluation profile is assigned. The evaluation profile user interface also comprises one or more parameter input fields configured to receive one or more additional user inputs identifying at least one of a selected wireless domain of a plurality of wireless domains, a selected service provider of a plurality of service providers associated with providing a network service to the communication network, a selected wireless technology of a plurality of wireless technologies associated with the network service, a selected time interval for monitoring the one or more selected KPIs based on performance data related to the network service, a geographical location within which the network service is provided, or at least one network device by which the network service is provided. The evaluation profile user interface further comprises one or more evaluation input fields configured to receive one or more anomaly detection instructions based upon which the one or more selected KPIs are processed to determine an anomalous condition of the one or more selected KPIs. The one or more evaluation input fields comprise an option to select at least one of an active anomaly for detecting an instance of the one or more selected KPIs being outside of an expected range based on current performance data received from at least one selected service provider or the at least one network device as the current performance data is received, or a predicted anomaly for detecting a forecast deviation of the one or more selected KPIs from the expected range based on a projected KPI value for at least one of the one or more selected KPIs determined based on historical performance data and a future time period indicated by way of one or more of the anomaly detection instructions. The apparatus is also caused to process the first user input, the one or more additional user inputs and the one or more anomaly detection instructions to generate the configured evaluation profile. The apparatus is further caused to process at least one of the received current performance data or the historical performance data based on the configured evaluation profile. The apparatus is additionally caused to cause an alert to be output to a network operator of the communication network based on a determination that the received current performance data or the historical performance data indicates the active anomaly or the predicted anomaly.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
causing, by a processor, an evaluation profile user interface to be output by a display, the evaluation profile user interface comprising:
a key performance indicator (KPI) input field configured to receive a first user input identifying one or more selected KPIs of a plurality of available KPIs, wherein each KPI of the plurality of available KPIs is indicative of a corresponding operating state of a communication network, a quantity of the one or more selected KPIs is less than a total quantity of the plurality of available KPIs, and the quantity of the one or more selected KPIs is less than or equal to a preset number based on a user credential associated with a user to which a configured evaluation profile is assigned;
one or more parameter input fields configured to receive one or more additional user inputs identifying at least one of a selected wireless domain of a plurality of wireless domains, a selected service provider of a plurality of service providers associated with providing a network service to the communication network, a selected wireless technology of a plurality of wireless technologies associated with the network service, a selected time interval for monitoring the one or more selected KPIs based on performance data related to the network service, a geographical location within which the network service is provided, or at least one network device by which the network service is provided;
one or more evaluation input fields configured to receive one or more anomaly detection instructions based upon which the one or more selected KPIs are processed to determine an anomalous condition of the one or more selected KPIs, the one or more evaluation input fields comprising an option to select at least one of an active anomaly for detecting an instance of the one or more selected KPIs being outside of an expected range based on current performance data received from at least one selected service provider or the at least one network device as the current performance data is received, or a predicted anomaly for detecting a forecast deviation of the one or more selected KPIs from the expected range based on a projected KPI value for at least one of the one or more selected KPIs determined based on historical performance data and a future time period indicated by way of one or more of the anomaly detection instructions;
processing the first user input, the one or more additional user inputs and the one or more anomaly detection instructions to generate the configured evaluation profile;
processing at least one of the received current performance data or the historical performance data based on the configured evaluation profile; and
causing an alert to be output to a network operator of the communication network based on a determination that the received current performance data or the historical performance data indicates the active anomaly or the predicted anomaly.

2. The method of claim 1, wherein the selected time interval for monitoring the one or more selected KPIs extends from a start time before a time the configured evaluation profile is generated to an end time after the time the configured evaluation profile is generated.

3. The method of claim 1, wherein the selected time interval for monitoring the one or more selected KPIs extends from a start time after a time the configured evaluation profile is generated to an end time after the start time.

4. The method of claim 1, further comprising:
causing a graphical view of the one or more selected KPIs over time to be output by the display based on an instruction to monitor the one or more selected KPIs.

5. The method of claim 4, wherein based on a determination that two or more selected KPIs are indicated based on the first user input, the two or more selected KPIs are caused to be simultaneously included in the graphical view.

6. The method of claim 1, wherein
the user credential indicates the user to which the configured evaluation profile is assigned is a first user having a first access-level type or a second user having a second access-level type corresponding to a higher level of admin rights than the first access-level type within a system for monitoring the one or more selected KPIs, and
the preset number based on the user credential is greater for the second user than the first user.

7. The method of claim 1, wherein the one or more evaluation input fields further comprises a threshold comparison parameter indicating a basis upon which the active anomaly or the predicted anomaly is determined.

8. The method of claim 7, wherein the threshold comparison parameter is one of greater than or less than a baseline threshold value, and the active anomaly or the predicted anomaly is determined based on an actual breach or a predicted breach of the baseline threshold value in accordance with the threshold comparison parameter.

9. The method of claim 7, wherein the threshold comparison parameter is a confidence band defining a range of a maximum threshold value and a minimum threshold value, and the active anomaly or the predicted anomaly is determined based on an actual breach or a predicted breach of the maximum threshold value or the minimum threshold value in accordance with the threshold comparison parameter.

10. The method of claim 7, wherein the threshold comparison parameter defines a tolerance range of change over time for the selected one or more KPIs, and the active anomaly or the predicted anomaly is determined based on an actual breach or a predicted breach of the tolerance range of change over time, indicating a trend of reduced quality of the network service, in accordance with the threshold comparison parameter.

11. An apparatus, comprising:
a processor; and
a memory having instructions stored thereon that, when executed by the processor, cause the apparatus to:
cause an evaluation profile user interface to be output by a display, the evaluation profile user interface comprising:
a key performance indicator (KPI) input field configured to receive a first user input identifying one or more selected KPIs of a plurality of available KPIs, wherein each KPI of the plurality of available KPIs is indicative of a corresponding operating state of a communication network, a quantity of the one or more selected KPIs is less than a total quantity of the plurality of available KPIs, and the quantity of the one or more selected KPIs is less than or equal to a preset number based on a user credential associated with a user to which a configured evaluation profile is assigned;
one or more parameter input fields configured to receive one or more additional user inputs identifying at least one of a selected wireless domain of a plurality of wireless domains, a selected service provider of a plurality of service providers associated with providing a network service to the communication network, a selected wireless technology of a plurality of wireless technologies associated with the network service, a selected time interval for monitoring the one or more selected KPIs based on performance data related to the network service, a geographical location within which the network service is provided, or at least one network device by which the network service is provided;
one or more evaluation input fields configured to receive one or more anomaly detection instructions based upon which the one or more selected KPIs are processed to determine an anomalous condition of the one or more selected KPIs, the one or more evaluation input fields comprising an option to select at least one of an active anomaly for detecting an instance of the one or more selected KPIs being outside of an expected range based on current performance data received from at least one selected service provider or the at least one network device as the current performance data is received, or a predicted anomaly for detecting a forecast deviation of the one or more selected KPIs from the expected range based on a projected KPI value for at least one of the one or more selected KPIs determined based on historical performance data and a future time period indicated by way of one or more of the anomaly detection instructions;
process the first user input, the one or more additional user inputs and the one or more anomaly detection instructions to generate the configured evaluation profile;
process at least one of the received current performance data or the historical performance data based on the configured evaluation profile; and
cause an alert to be output to a network operator of the communication network based on a determination that the received current performance data or the historical performance data indicates the active anomaly or the predicted anomaly.

12. The apparatus of claim 11, wherein the selected time interval for monitoring the one or more selected KPIs extends from a start time before a time the configured evaluation profile is generated to an end time after the time the configured evaluation profile is generated.

13. The apparatus of claim 11, wherein the selected time interval for monitoring the one or more selected KPIs extends from a start time after a time the configured evaluation profile is generated to an end time after the start time.

14. The apparatus of claim 11, further comprising:
causing a graphical view of the one or more selected KPIs over time to be output by the display based on an instruction to monitor the one or more selected KPIs.

15. The apparatus of claim 14, wherein based on a determination that two or more selected KPIs are indicated based on the first user input, the two or more selected KPIs are caused to be simultaneously included in the graphical view.

16. The apparatus of claim 11, wherein
the user credential indicates the user to which the configured evaluation profile is assigned is a first user having a first access-level type or a second user having a second access-level type corresponding to a higher level of admin rights than the first access-level type within a system for monitoring the one or more selected KPIs, and
the preset number based on the user credential is greater for the second user than the first user.

17. The apparatus of claim 11, wherein the one or more evaluation input fields further comprises a threshold comparison parameter indicating a basis upon which the active anomaly or the predicted anomaly is determined.

18. The apparatus of claim 17, wherein the threshold comparison parameter is one of greater than or less than a baseline threshold value, and the active anomaly or the predicted anomaly is determined based on an actual breach or a predicted breach of the baseline threshold value in accordance with the threshold comparison parameter.

19. The apparatus of claim 17, wherein the threshold comparison parameter is a confidence band defining a range of a maximum threshold value and a minimum threshold value, and the active anomaly or the predicted anomaly is determined based on an actual breach or a predicted breach of the maximum threshold value or the minimum threshold value in accordance with the threshold comparison parameter.

20. A non-transitory computer readable medium having instructions stored thereon that, when executed by a processor, cause an apparatus to:
cause an evaluation profile user interface to be output by a display, the evaluation profile user interface comprising:
a key performance indicator (KPI) input field configured to receive a first user input identifying one or more selected KPIs of a plurality of available KPIs, wherein each KPI of the plurality of available KPIs is indicative of a corresponding operating state of a communication network, a quantity of the one or more selected KPIs is less than a total quantity of the plurality of available KPIs, and the quantity of the one or more selected KPIs is less than or equal to a preset number based on a user credential associated with a user to which a configured evaluation profile is assigned;
one or more parameter input fields configured to receive one or more additional user inputs identifying at least one of a selected wireless domain of a plurality of wireless domains, a selected service provider of a plurality of service providers associated with providing a network service to the communication network, a selected wireless technology of a plurality of wireless technologies associated with the network service, a selected time interval for monitoring the one or more selected KPIs based on performance data related to the network service, a geographical location within which the network service is provided, or at least one network device by which the network service is provided;
one or more evaluation input fields configured to receive one or more anomaly detection instructions based upon which the one or more selected KPIs are processed to determine an anomalous condition of the one or more selected KPIs, the one or more evaluation input fields comprising an option to select at least one of an active anomaly for detecting an instance of the one or more selected KPIs being outside of an expected range based on current performance data received from at least one selected service provider or the at least one network device as the current performance data is received, or a predicted anomaly for detecting a forecast deviation of the operating state from the expected range based on a projected KPI value for at least one of the one or more selected KPIs determined based on historical performance data and a future time period indicated by way of one or more of the anomaly detection instructions;
process the first user input, the one or more additional user inputs and the one or more anomaly detection instructions to generate the configured evaluation profile;
process at least one of the received current performance data or the historical performance data based on the configured evaluation profile; and
cause an alert to be output to a network operator of the communication network based on a determination that the received current performance data or the historical performance data indicates the active anomaly or the predicted anomaly.
